(19) United States
(12) Patent Application Publication
(10) Pub. No.: US 2025/0265647 A1
(43) Pub. Date: Aug. 21, 2025

(54) BLOCKCHAIN-BASED SOFTWARE-AS-A-SERVICE PLATFORM FOR AUTOMATICALLY COORDINATING REVERSE TRANSACTIONS

(71) Applicant: McEnroe Group, LLC, Greenwich, CT (US)

(72) Inventor: William McEnroe, Greenwich, CT (US)

(21) Appl. No.: 19/055,346

(22) Filed: Feb. 17, 2025

Related U.S. Application Data
(60) Provisional application No. 63/554,332, filed on Feb. 16, 2024.
(60) Provisional application No. 63/554,338, filed on Feb. 16, 2024.
(60) Provisional application No. 63/554,344, filed on Feb. 16, 2024.
(60) Provisional application No. 63/554,351, filed on Feb. 16, 2024.

(51) Int. Cl. G06Q 40/04; G06Q 20/38

(52) U.S. Cl. CPC G06Q 40/04; G06Q 20/389

(57) ABSTRACT

The present disclosure provides a method for deal management and blockchain execution is disclosed. The method utilizes a blockchain-based platform to securely store and verify data related to investing entities, including their risk tolerance, investment goals, and regulatory compliance. The system determines a subset of entities with shared interests in a specific investment, generating a set of profiles associated with each entity based on historical deal data. These profiles are used to inform investment decisions and monitor portfolio performance. The platform also verifies accreditation statuses of the investing entities through blockchain-based consensus rules, providing an immutable record of investor accreditation status. Additionally, the system provides real-time transaction records to generate accurate and up-to-date reports for investors and deal sponsors, leveraging blockchain-based data storage and verification capabilities.

### CROSS-REFERENCE TO RELATED APPLICATIONS

This application claims priority from U.S. provisional application 63/554,332 filed Feb. 16, 2024, U.S. provisional application 63/554,338 filed Feb. 16, 2024, U.S. provisional application 63/554,344 filed Feb. 16, 2024, U.S. provisional application 63/554,351 filed Feb. 16, 2024, the disclosures of which are incorporated herein by reference.

### BACKGROUND OF THE INVENTION

### 1. Field of the Disclosure

The present disclosure is generally related to systems and methods relating to online platforms that support automated coordination of reverse co-investment transactions.

### 2. Description of the Related Art

Various types of online transactions may be difficult to coordinate due to scarcity of comprehensive, accessible, and comprehensible information relating to the respective transaction. As a result, services supporting such transactions (e.g., private equity) may often involve high fees, significantly diminishing an investor's overall returns. Such fees may include management and performance-based fees and may erode the gains from successful investments. For instance, an investor may find that a substantial portion of their profits is absorbed by these fees, ultimately reducing the attractiveness of such investments. The private equity landscape is generally characterized by such scarcity of comprehensive and accessible information about potential transactions. This limited information can pose a formidable challenge for users seeking to make well-informed decisions under complicated circumstances impacted by multiple different factors.

For example, an investor in an early-stage technology startup may experience losses if some invested companies fail to achieve their growth targets or face unforeseen challenges in the competitive market. The private equity arena frequently grapples with issues of illiquidity and fraud. Illiquidity means that investors may not have the flexibility to access their capital when needed, as investments typically have long lock-up periods. Moreover, investors may encounter fraudulent schemes or misrepresentations by parties offering private equity opportunities, potentially resulting in financial losses and legal disputes. One of the inherent challenges in private equity is the extended investment horizon required. Investors often must commit their capital for several years, if not decades, before realizing returns. This lengthy commitment can be restrictive, especially when an investor's financial circumstances or goals change over time, making it difficult to adapt their portfolio to evolving needs and opportunities.

Private equity investments may be reserved for high-net-worth individuals and institutional investors, excluding a significant portion of the population from participating in potentially lucrative ventures. For example, many qualified retail investors may miss out on opportunities to invest in innovative startups with high growth potential due to limited access to such deals. Identifying promising investment opportunities and conducting comprehensive due diligence can be time-consuming and resource-intensive. As an example, a potential investor may struggle to source and vet early-stage startups with the potential for high returns, as these companies may lack visibility in the broader investment landscape.

### SUMMARY OF THE CLAIMED INVENTION

Embodiments of the present disclosure include systems and methods for automated filtering, display, and management of transaction data using blockchain. A blockchain-based platform may be used to securely store and verify data related to different entities, including their respective risk tolerance, goals, and regulatory compliance. The system determines a subset of entities with shared interests in a specific investment, generating a set of profiles associated with each entity based on historical deal data. These profiles are used to inform investment decisions and monitor portfolio performance. The platform also verifies accreditation statuses of the investing entities through blockchain-based consensus rules, providing an immutable record of investor accreditation status. Additionally, the system provides real-time transaction records to generate accurate and up-to-date reports for investors and deal sponsors, leveraging blockchain-based data storage and verification capabilities.

### BRIEF DESCRIPTION OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a reverse co-investment SaaS platform.

FIG. 2 illustrates an example method performed by a manage module.

FIG. 3 illustrates an example method performed by an AIA module.

FIG. 4 illustrates an example method performed by a KYC module.

FIG. 5 illustrates an example method performed by a deal module.

FIG. 6 illustrates an example method performed by an SPV module.

FIG. 7 illustrates an example method performed by a gift module.

FIG. 8 illustrates an example method performed by a closing module.

FIG. 9 illustrates an example method performed by a reports module.

FIG. 10 illustrates an example method performed by an AI analytics module.

FIG. 11 illustrates an example method performed by a blockchain module.

FIG. 12 illustrates an example method of deal management and blockchain execution.

FIG. 13 illustrates a block diagram of an exemplary computing system that may be used to implement the present technology.

FIG. 14 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

The present technology introduces a method for enabling a reverse co-investment network within the context of a software-as-a-service (SaaS) platform. Such a network may further leverage blockchain technology to revolutionize the way investors participate alongside primary initial investors in pre-funded transactions. By harnessing the capabilities of blockchain, this invention establishes a robust and secure foundation for facilitating reverse co-investments. Central to this innovation is a searchable database of deals underpinned by blockchain's transparent and immutable ledger system. Within this database, investors gain access to comprehensive information about each deal, including essential details such as the investment amount, target company, and risk level. Blockchain ensures the accuracy and integrity of this information, instilling confidence among users.

Moreover, the blockchain-powered network equips investors with the ability to seamlessly track the performance of their investments in real-time. The decentralized ledger records all transactional data, providing investors with a continuous, transparent, and up-to-date view of their portfolio's performance. This real-time monitoring enhances investor decision-making, enabling prompt adjustments to investment strategies as market conditions evolve. In addition to providing access to pre-funded opportunities, the present invention fosters a community of user investors by offering communication functionalities within the network. Blockchain technology ensures secure and transparent communication channels, allowing investors to exchange insights, collaborate on investment decisions, share valuable knowledge, and provide the capacity to democratize investment opportunities.

Additionally, the private equity industry has traditionally been dominated by institutional investors and high-net-worth individuals due to the substantial minimum investment requirements. This threshold often precludes smaller investors from participating in potentially lucrative private equity deals. Moreover, the industry's exclusivity restricts the diversification opportunities for smaller investors, as they are unable to tap into high-growth potential ventures that are typically reserved for a more affluent clientele.

Private equity transactions are known for their complexity and opaqueness. Unlike public markets, private equity often operates with limited disclosure, making it challenging for investors to perform due diligence and assess the true risk and potential of investments. This lack of transparency can lead to information asymmetry, where investors might not have access to all the information required to make informed decisions, potentially resulting in suboptimal investment choices.

The process of matching investors with investment opportunities in private equity can be inefficient and time-consuming. Traditional methods involve extensive networking and relationship-building to discover and access deals. This inefficiency can lead to delayed capital allocation, missed investment opportunities, and suboptimal capital distribution across various sectors and stages of business development. The time-intensive nature of these processes can hinder the agility of investment strategies in rapidly changing market conditions.

Therefore, it may be useful to have a system that democratizes access to private equity investments, allowing a broader range of investors to participate in opportunities previously reserved for a select few. Such a system might also enhance transparency, providing detailed information about investment opportunities and reducing information asymmetry. Furthermore, an improved mechanism for efficiently matching investor capital with suitable private equity deals could streamline the investment process, optimize capital allocation, and enable quicker response to market conditions. This system could potentially revolutionize the private equity space, making it more inclusive, informed, and agile for investors of all sizes and experiences.

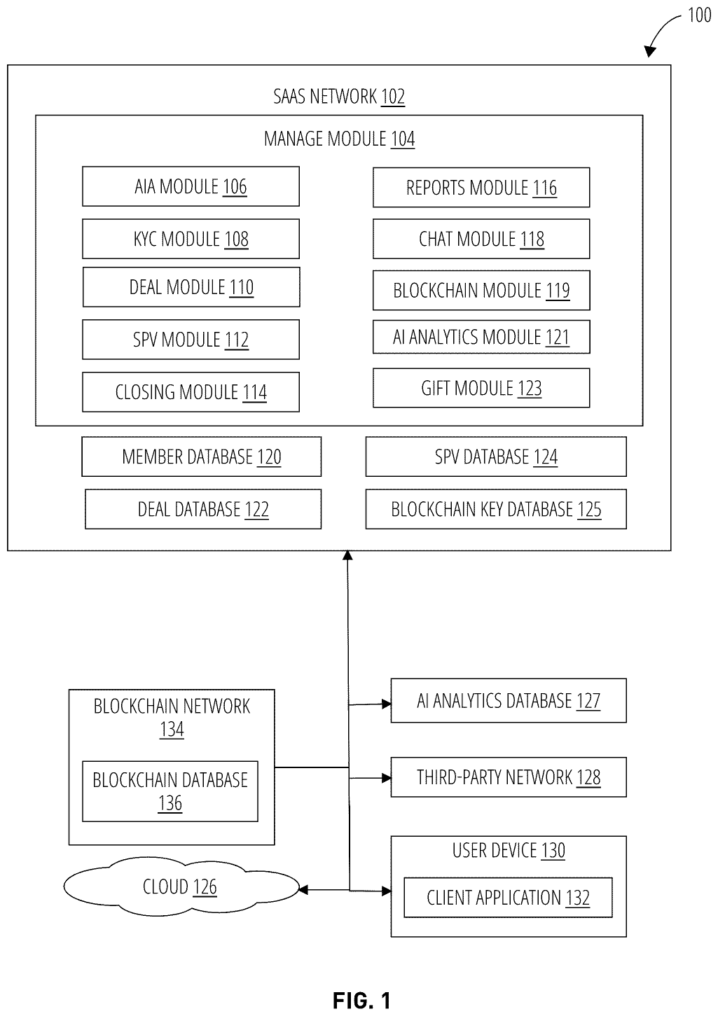

FIG. 1 illustrates a reverse co-investment SaaS platform.

The reverse co-investment SaaS platform 100 may be comprised of a SaaS network 102, which may allow for the development, deployment, and management of the infrastructure, tools, and services needed to build and run applications in this invention. The SaaS network 102 may provide the operational platform for manage module 104 and associated modules, such as AIA module 106, KYC module 108, deal module 110, SPV module 112, closing module 114, reports module 116, chat module 118, blockchain module 119, AI analytics module 121, and gift module 123. SaaS network 102 may contain a member database 120, which encompasses information relating to user investors interested in participating in investment deals contained in deal database 122. The SaaS network 102 may contain necessary tools and libraries, programming languages, security, frameworks, and databases relating to the member database 120, deal database 122, and the SPV database 124.

The reverse co-investment SaaS platform 100 may further include a manage module 104, which may include facilitating user interactions with the SaaS network 102 and initiate other modules, including AIA module 106, KYC module 108, deal module 110, SPV module 112, closing module 114, reports module 116, chat module 118, blockchain module 119, AI analytics module 121, and gift module 123 and coordinate access to the member database 120, deal database 122 and SPV database 124.

The reverse co-investment SaaS platform 100 may further include a member accredited investor affidavit (AIA) module 106 that may establish accreditation of user investors accessing the SaaS network 102. The AIA module 106 may collect member information about net worth, income, occupation, and investment experience. The AIA module 106 may ensure that only accredited investors can participate in and access the SaaS network 102. User investors accredited by the AIA module 106 may be approved to bear the risks associated with investment opportunities in the deal database 122 and access the deal module 110. The AIA module 106 may protect the SaaS network 102 from liability by requiring members to attest to their accredited investor status, avoiding any legal challenges that may arise if a non-accredited investor suffers investment losses. The AIA module 106 may ensure effective due diligence procedures with sufficient investigation and validation procedures compliant with all applicable laws and regulations.

The reverse co-investment SaaS platform 100 may further include a know your customer module (KYC) 108, which may create a profile of the user investor that may be used to present specific deals in deal module 110 in the SaaS network 102. The KYC module 108 may collect information about the user investor's investment goals, risk tolerance, psychology profile, and financial resources. Information collected by the KYC module 108 can then be used to match the user investor with deals that fit their investment profile well. Additionally, the KYC module 108 could potentially integrate with the AI analytics module 121 to employ advanced data analysis techniques, further enhancing its capability to match user investors with suitable investment opportunities based on their unique profiles.

When a gift transaction is initiated through the gift module 123, it may trigger the KYC module 108 to conduct enhanced due diligence, verifying the identities of both the donor and recipient. This process is vital for anti-money laundering checks, ensuring that high-value asset transfers comply with legal standards and are not used for illicit activities.

Additionally, the gift module 123 may provide valuable data that aids the KYC module 108 in updating and enriching customer profiles, thereby maintaining accurate and current information on SaaS network 102 participants. This interaction between the gift module 123 and the KYC module 108 is essential for the network's adherence to regulatory requirements and for conducting comprehensive risk assessments, ensuring that gift transactions are secure, legitimate, and compliant with financial regulations.

The reverse co-investment SaaS platform 100 may further include a deal module 110, which may manage the deal flow for SaaS network 102 and identify potential deals that are a good fit for the user investor. The deal module 110 may customize the presentation to the user investor based on their needs and KYC profile. For example, the deals from the deal module 110 may present information in a different order, or the information about the deals may be highlighted differently, depending on the user investor's investment goals derived from their KYC profile. The deal module 110 may also use machine learning to personalize the presentation of the deals.

For example the deal module 110 can learn which features of the deals are most important to the user investor and then highlight those features for a customized presentation, assisting the user investor to find appropriate investments more quickly and easily. The deal module 110 may ensure the deal flow is managed efficiently and effectively on the SaaS network 102. The deal module 110 ensures transparency and communications with the user investors via the chat module 118, building trust and confidence in the SaaS network 102. The deal module 110 could utilize advanced algorithms, possibly in conjunction with the AI analytics module 121, to match deals with user investors, enhancing the relevance and appeal of these opportunities. It may also feature capabilities for managing the deal flow and ensuring efficient communication of deal-related information, possibly integrating machine learning techniques to personalize the experience for each user investor.

The reverse co-investment SaaS platform 100 may further include a gift module 123, which may be designed to offer a comprehensive and user-friendly interface for managing the nuances of asset gifting within the SaaS network 102. The gift module 123 may integrate seamlessly with the SaaS network 102, which may allow user investors to initiate the gifting process with ease while supporting various asset types, including stocks, bonds, and shares in investment projects. The gift module 123 may interface with the KYC module 108 to automate compliance checks, ensuring adherence to relevant laws and regulations, particularly concerning tax implications. It may be equipped to set limits on gift values in accordance with legal thresholds across different jurisdictions.

Additionally, the gift module 123 may offer robust tools for tax documentation and reporting, generating necessary reports and forms for both the giver and the recipient. The gift module 123 may facilitate trust creation, which may include functionalities for trust setup, trustee appointment, and asset transfer into trusts. The gift module 123 may manage recipient details, including identity verification and acceptance management, and maintain comprehensive records of all transactions. These records may detail asset types, involved parties, transaction dates, and other pertinent information essential for auditing and compliance.

A notification system of the gift module 123 may inform all parties about the status of their gifts, from initiation to completion and may also integrate with the SaaS 102 customer support functionality and may provide users with assistance for any queries or issues. To ensure the security of sensitive information, the gift module 123 may incorporate advanced security measures. The gift module 123 may offer customization options for the gifting process, such as attaching conditions or scheduling future transfers, and may also provide user investors with educational resources about the implications of gifting, including tax and legal considerations.

The gift module 123 may include analytics and report functions through the reports module 116, offering users a comprehensive view of their gifting activities and their impact on overall investment strategies. The gift module 123 may integrate seamlessly with other modules within the SaaS Network 102, such as the AIA module 106, the KYC module 108, the deal module 110, the SPV module 112, the closing module 114, and the reports module 116, to ensure cohesive and synchronized operations. This integration may be vital for facilitating end-to-end process flows in gift and trust management, from the initial setup of gifts to the final execution of gifting and trust-related transactions and reporting. The gift module 123 may trigger automated workflows and notifications, streamlining operations and reducing the potential for human error.

The gift module 123 may provide scalability and flexibility capable of adapting to a diverse range of gifting and trust structures and accommodating the evolving needs of the SaaS Network 102 user investors, which may include customizable options to cater to varying legal agreements and user investor preferences, thereby enhancing user experience and satisfaction and unparalleled value in managing gifting, legal trusts, and fiduciary responsibilities.

The reverse co-investment SaaS platform 100 may further include a Special Purpose Vehicle (SPV) module 112 that may generate the paperwork needed to file for a legal entity that is created for a specific investment. An SPV may be used to pool the funds of user investor(s) and invest in a single entity. The SPV module 112 may create and manage the SPVs, including specific transactions related to the deal. It may create the SPV and file the necessary paperwork with the appropriate government agencies to manage the SPV on behalf of the user investors, including accounting reporting and legal compliance. An SPV may be used to pool the funds of user investor(s) and invest in a single entity. The SPV module 112 may create and manage the SPVs, including specific transactions related to the deal, and may perform the creation of the SPV and filing the necessary paperwork with the appropriate government agencies, manage the SPV on behalf of the user investors, which may include accounting reporting and legal compliance.

The gift module 123 may interact with the SPV module 112 in the context of creating specific gifting and trust documents within the SPV module 112, managing oversight of asset gifting, management of trust documents, and ensuring compliance with trust agreements and facilitating secure asset distribution.

The reverse co-investment SaaS platform 100 may further include a reports module 116 that may generate and distribute reports on the deal. The reports module 116 may compile information on the financial performance of the deal, such as the return on investment (ROI), net present value (NPV), and internal rate of return (IRR). The reports module 116 may create K1 forms for user investor(s) and other tax-related documents, such as capital gains statements and loss carryforward reports. The reports module 116 may provide a real-time view of the investment, including the latest financial information and deal updates. The reports module 116 may allow user investors access and the sharing of reports.

The reports module 116 may ensure compliance with the regulatory requirements of the SPV. The reports module 116 may generate a variety of reports such as portfolio performance reports over time, user investor performance reports showing individual user investor performance, investment opportunity reports from the deal module 110, funding round reports from the SPV database 124, and the amount of capital raised and number of user investors. The reports module 116 may use a variety of analytical techniques to generate reports, such as statistical analyses, machine learning, and natural language processing. Additionally, the reports module 116 may interact with the AI analytics module 121 to enhance its reporting capabilities, potentially utilizing advanced analytics to offer predictive insights and trends analysis.

The reverse co-investment SaaS platform 100 may further include the AI analytics module 121 as a significant addition that is designed to harness advanced artificial intelligence technologies to continuously augment the platform's capabilities. This module is responsible for persistently monitoring and analyzing data from the member database 120, deal database 122, and SPV database 124, ensuring that its AI models are regularly updated with new information. A notable aspect of the AI analytics module 121 is its utilization of various AI methodologies for different applications. For example, it might employ correlation coefficients to unearth patterns and associations within investor data in the member database 120, aiding in the discovery of crucial factors that influence investment decisions. This insight can lead to more precise and effective investment matching in the KYC module 108.

In another application, the module may leverage supervised machine learning algorithms to forecast the potential success of deals in the deal database 122. By analyzing historical data and outcomes, it assists the deal module 110 in offering investment opportunities to user investors that are more likely to be successful. A working example of this can be envisaged where the AI analytics module 121 scrutinizes past investment trends and investor behaviors, pinpointing that investors with specific characteristics (e.g., high net worth, an interest in sustainable energy) often opt for particular types of deals (e.g., renewable energy startups). Utilizing this information, when a new renewable energy deal is entered into the deal database 122, the module could flag this deal as a prime opportunity for similar investor profiles within the KYC module 108.

As a result, the deal module 110 would then give higher priority to this deal for those investors, enhancing the relevance of deal matches and potentially increasing the rate of successful investments. The AI analytics module 121, therefore, plays a critical role in dynamically elevating the intelligence and adaptability of the entire Reverse Co-Investment Platform, rendering it more responsive, efficient, and tailored to user needs.

The reverse co-investment SaaS platform 100 may further include a chat module 118 that may facilitate secure and private communication between the parties relating to the investment to all components in the SaaS network 102. The chat module 118 may facilitate transaction notifications to all parties involved in the investment whenever a transaction occurs, such as closing confirmation from the closing module 114, capital contribution through the investment, or distribution in the deal module 110 and report module 116. The chat module 118 may facilitate communication between all parties in the SaaS network 102 with real-time visibility into the investment, such as the latest financial information and deal updates contained in the deal module 110 and deal database 122.

The chat module 118 may ensure all parties are informed about the investment in the deal module 110 and provide a clear line of communication between parties. The chat module 118 may improve transparency and efficiency in the investment process in the SaaS network 102. The chat module 118 may include features such as real-time messaging file sharing such as investment documents and financial reports in reports module 116, a chat room where user investors may discuss specific topics. In these search functions, user investors can search for specific messages and files, notification where user investors may receive notifications when a message is sent or a file is shared.

The chat module 118 may be integrated with other modules on the SaaS network 102. The chat module 118 may use a variety of security technologies such as encryption and authentication to protect user investor privacy. The chat module 118 may use a variety of data storage technologies such as cloud 126 and database storage relating to the member database 120, deal database 122, and SPV database 124. The Chat module may use bot features to automate tasks, translate messages into different languages, and transcribe messages into text format.

The reverse co-investment SaaS platform 100 may further include a blockchain module 119, which may be integrated into the SaaS network 102, enhancing authentication and user management systems to strengthen both security and transparency. The blockchain module 119 may interact with modules within the SaaS network 102 to streamline the investment process and provide a secure and auditable record of transactions. The blockchain module 119 may interact with the AIA module 106 to verify the accreditation status of potential investors, which may include validating investor credentials and ensuring they meet the regulatory requirements for participating in private investment opportunities. The blockchain's immutable record of investor accreditation status may provide a reliable source of verification for deal sponsors and regulators. The blockchain module 119 may interact with the KYC module 108 to streamline the identity verification process for investors. By leveraging blockchain's secure and tamper-proof nature, investor identity documents may be stored and verified efficiently, reducing the risk of fraud and ensuring compliance with KYC regulations.

The blockchain module 119 may interact with the deal module 110 to provide a transparent and auditable record of deal terms and investor commitments and details, which may include in-vestment amounts, ownership percentages, and transaction timestamps, which may be securely stored on the blockchain, providing an immutable record for all parties involved. The blockchain module 119 may interact with the SPV module 112 to manage the creation and operation of SPVs. By leveraging smart contracts on the blockchain, the blockchain module 119 may automate the SPV formation process, ensuring compliance with regulatory requirements and streamlining investor onboarding.

The blockchain module 119 may interact with the closing module 114 to facilitate secure and transparent fund transfers between investors and SPVs, which may include blockchain-based escrow services that may be utilized to hold investor funds until deal conditions are met, ensuring secure and verifiable transactions. The blockchain module 119 may interact with the reports module 116 to provide real-time data and insights on investment performance and deal progress by accessing blockchain-based transaction records, which may generate accurate and up-to-date reports for investors and deal sponsors. Integrating blockchain module 119 into the SaaS network 102 may enhance trust, transparency, and efficiency across the investment life cycle and may facilitate secure transactions, streamlining regulatory compliance, and providing a reliable source of data for informed decision-making.

The reverse co-investment SaaS platform 100 may further include a closing module 114 that may execute the terms of the deal and transfer the funds from the user investor to the SPV. The closing module 114 may finalize deal confirmation and agreement to the terms of the investment; coordination with banking entities, the investee company, other third parties, digital signatures, and Letter of intent (LOI), including key terms (T&C) of the investment; Legal documents of the parties including the investment agreement, shareholders' agreement, and escrow agreement and associated fees in the SPV. The closing module 114 provides a record of the process related to the closing. The closing module 114 may use a variety of technologies such as electronic signatures, blockchain, smart contracts, encryption, and AI.

The gift module 123 may interact with the closing module 114 by assessing and validating transactions related to asset gifting and trusts, ensuring they adhere to the terms of the asset distribution, trust, and legal requirements. If the gift module 123 flags an issue, the closing module 114 may halt, delay, or modify the transaction accordingly, ensuring all gift and trust-related transactions comply with legal and regulatory standards. The closing module 114 may synchronize data with the SPV database 126 to ensure accuracy in the final stages of transactions, which may require updating transaction status and beneficiary information. The closing module 114 may provide a record of the process related to the closing. The closing module 114 may use a variety of technologies such as electronic signatures, blockchain, smart contracts, encryption, and AI.

The reverse co-investment SaaS platform 100 may further include a member database 120 that may contain information including the user investor's name, contact information, i.e., email address and phone number, investment size, the user investor's investment interests, the user investor investment experience with private equity investments, and the user investor's risk tolerance. The member database 120 may contain the identity of the user investor(s) who are interested in co-investing in specific transactions and access the investment interests, experience, goals, restrictions, and risk tolerance determined by the AIA module 106 and KYC module 108. The member database 120 may include the KYC profile that may be used to identify and match potential co-investment opportunities that are a good fit for the user investors. The gift module 123 may interact with the member SPV database 124 in the SaaS network 102 to verify member identities, update profiles with transaction details, determine eligibility for gifts and/or trusts, facilitate communication, enable data analysis, and ensure compliance and accurate record-keeping which may be crucial for the smooth operation and integrity of the SaaS network 102 gift transaction processes.

Below are a couple of different examples of member databases 120.

| | Demographic | Financial | | Investment | Investment | KYC Profile |
|---|---|---|---|---|---|---|
| User Investor | Data | Information | Preference | Type | History | Example |
| Ms. Martinez | Age: 35, New | Net Worth: | Renewable | Medium- | Invested in | martinezprofile.dat |
| | York | $500,000 | Energy | duration | GreenTech Ltd | |
| Mr. Kim | Age: 28, San | Annual Income: | Agri-Tech | Short-term | Invested in | kimprofile.dat |
| | Francisco | $80,000 | | | FarmTech Corp | |
| Mr. Smith | Age: 42, | Net Worth: | Technology | Long-term | Invested in | smitprofile.dat |
| | Boston | $1,000,000 | | | TechStart Inc | |
| . . . | . . . | . . . | . . . | . . . | . . . | . . . |

### Example Member Database 120

| | | | | Investment | | | |
|---|---|---|---|---|---|---|---|
| ID | Name | Investor Type | Contact Information | Focus | Investment Criteria | Join Date | KYC Profile |
| 1 | John | Angel | johndoe@email.com, | Early-stage | Strong founding | Jun. 15, 2021 | Sophisticated investor, |
| | Doe | Investor | +123456789, 123 | SaaS | team, scalable | | interested in speculative, |
| | | | Angel St, Tech City | startups, AI- | product | | high return investment, |
| | | | | driven | | | funds are sourced from |
| | | | | platforms | | | personal wealth. |
| 2 | Emily | Venture | emily@vcfirm.com, | Series A and | Proven market fit, | Sep. 10, 2020 | Investment funds are |
| | Smith | Capitalist | +123987654, 456 | B, SaaS in | strong revenue | | sourced from the VC firm |
| | | | Venture Blvd, | healthcare | growth | | and personal wealth |
| | | | Capital City | and fintech | | | accumulated through her |
| | | | | | | | career. |
| 3 | Richard | Corporate | richard.lee@bigtechcomp.com, | Strategic | Strategic alignment | Jan. 20, 2022 | Focus on strategic |
| | Lee | Investor | +123555666, 789 | partnerships | with corporate goals, | | business investments, |
| | | | Corporate Park, | in SaaS, B2B | scalability | | authority to make |
| | | | Industry City | software | | | investment decisions, |
| | | | | | | | compliance checks |
| | | | | | | | complete |
| 4 | Sarah | Crowdfunding | sarahj@crowdfundme.com, | Consumer- | High community | Nov. 5, 2021 | Individual investor |
| | Johnson | Investor | +123333444, | focused SaaS, | Impact, innovative | | engaged in crowdfunding |
| | | | 101 Crowd Ave, | green tech | product | | platforms, investments are |
| | | | Startup City | | | | small-scale, sourced from |
| | | | | | | | personal savings, |
| | | | | | | | activities in consumer- |
| | | | | | | | focused startups. |

### Example Member Database 120

| | | Financial | | | Investment | |
|---|---|---|---|---|---|---|
| User Investor | Demographic Data | Information | Preference | Investment Type | History | KYC Profile Example |
| Ms. Martinez | Age: 35, New York | Net Worth: | Renewable Energy | Medium-duration | Invested in | martinezprofile.dat |
| | | $500,000 | | | GreenTech Ltd | |
| Mr. Kim | Age: 28, San | Annual Income: | Agri-Tech | Short-term | Invested in | kimprofile.dat |
| | Francisco | $80,000 | | | FarmTech Corp | |
| Mr. Smith | Age: 42, Boston | Net Worth: | Technology | Long-term | Invested in | smitprofile.dat |
| | | $1,000,000 | | | TechStart Inc | |
| . . . | . . . | . . . | . . . | . . . | . . . | . . . |

### Example Member Database 120

| ID | Name | Type | Contact Info | Focus | Investment Criteria | Join Date | KYC Profile |
|---|---|---|---|---|---|---|---|
| 1001 | Alice | Individual | alice.green@email.com | Renewable | Long-term Growth | Apr. 12, 2021 | Sophisticated investor, |
| | Green | | | Energy | | | eco-conscious, |
| | | | | | | | personal wealth |
| 1002 | Beta | Institutional | contact@betacapital.com | Tech Startups | High Risk/Reward | Sep. 5, 2020 | Institutional entity, |
| | Capital | | | | | | high-risk tech ventures, |
| | | | | | | | corporate funds |
| 1003 | Charlie | Angel | charlie.yu@investor.net | Biotechnology | Early Stage, High | Jan. 20, 2022 | Angel investor, biotech |
| | Yu | Investor | | | Potential | | focus, personal and |
| | | | | | | | external funds |
| 1004 | Delta | Venture | vc@delta.com | AI and | Scalability, Market | ######### | VC firm, AI and |
| | Ventures | Capital | | Robotics | Fit | | robotics, pooled |
| | | | | | | | investment funds |

### Example Member Database 120

The reverse co-investment SaaS platform 100 may further include a deal database 122 that may contain information on potential investment opportunities. The deal database 122 may contain information such as Deal ID, a unique identifier for the deal, company name, the name of the company that is the target of the investment, the industry that the company operates in, the amount of capital that the company is seeking to raise and status of the investment (e.g., open, closed, withdrawn). The deal database 122 could be instrumental for the deal module 110, offering a rich source of data for presenting investment opportunities to users and for the AI analytics module 121 to analyze and identify patterns or trends in investment preferences. The gift module 123 may interact with the deal database 122 to enhance the efficiency and effectiveness of handling gift transactions related to investment deals. When a gift transaction is initiated through the gift module 123, it may access the deal database 122 to retrieve relevant information about investment deals, such as deal structure, valuation, and participant details. This interaction may ensure that gifts related to specific deals are accurately recorded and aligned with the current deal parameters. Furthermore, the gift module 123 may update the deal database 122 with information about the gift transaction, thereby maintaining an up-to-date record of the deal's status and the involvement of various parties. This seamless integration allows for the synchronization of gift transaction data with ongoing deal data, ensuring consistency and accuracy in the network's records and facilitating informed decision-making for all relevant parties.

Below are a couple of different examples of deal databases 122.

| Unique_Identifier | Company_Name | Industry_Category | Targeted_Investment_Amount |
|---|---|---|---|
| D12345 | TechAI Innovations | AI Technology | $1,500,000 |
| D12346 | DataStream Dynamics | Data Analytics | $2,200,000 |
| D12347 | Neural Nexus | Neural Networks | $1,800,000 |
| D12348 | GreenGrow | Agriculture Tech | $900,000 |
| | Agricultures | | |
| . . . | . . . | . . . | . . . |

### Example Deal Database 122

| | | | Targeted |
|---|---|---|---|
| Unique_{—} | | | Investment |
| Identifier | Company_Name | Industry_Category | Amount |
| D12345 | ZIPA Industries | AI Technology | $1,500,000 |
| D12346 | DataSpecialties Inc | Data Analytics | $2,200,000 |
| D12347 | NextGen Corp | Neural Networks | $1,800,000 |
| D12348 | Agratech Inc | Agriculture Tech | $900,000 |

### Example Deal Database 122

| | | Industry | Financial |
|---|---|---|---|
| Deal Code | Company Name | Category | Commitment |
| D12345 | XYZ Innovations | AI Technology | $1.5 million |
| D12346 | HealthCo Solutions | Healthcare | $2 million |
| D12347 | FinTech Global | Finance | $3 million |
| D12348 | EcoEnergy Corp. | Renewable Energy | $1 million |

### Example Deal Database 122

The reverse co-investment SaaS platform 100 may further include an SPV database 124 that may contain information SPV's created by the SPV module 112. The SPV database 124 may contain the SPV ID, fund name that created the SPV, company name or target of the investment, industry that the company operates in, the amount of capital that the SPV has invested in the company, the SPV status (e.g., open, closed, withdrawn), and the summary of the SPV investment.

Below are a couple of different examples of SPV databases 124.

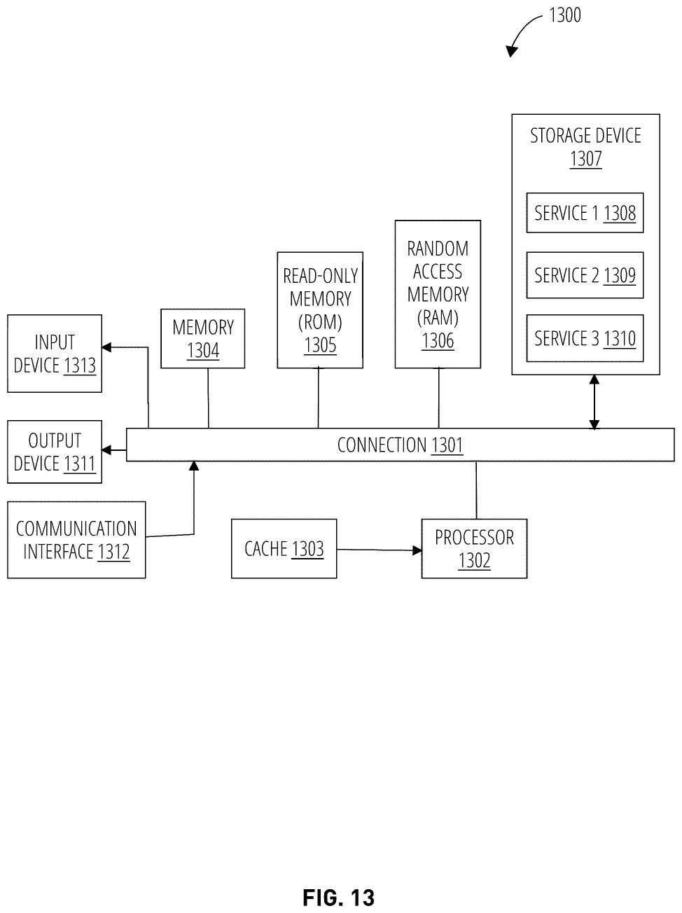

TABLE 1
SPV Details (FIG. 13A)

| SPV ID | Official Name | Date of Inception | Projected Closure Date | Main Objective |
|---|---|---|---|---|
| SPV-89101 | Genius Capital Partners | 3 Apr. 2021 | 30 Apr. 2028 | Investment Management |

TABLE 2
Associated Private Equity Firms (FIG. 13B)

| PE Firm ID | Name | Contact Email | Phone Number | Address |
|---|---|---|---|---|
| EquityGroup-DEF | Sunset Equity Holdings | connect@sunsetequity.com | 123-456-7890 | 123 Sunset Blvd |

TABLE 3
Investor Data (FIG. 13C)

| | | | | Investment Agreement |
|---|---|---|---|---|
| Investor ID | Name/Affiliation | Investment Amount | Contact Info | Details |
| Investor-C891 | James Brown | $3,000,000 | jamesb@email.com | Direct gift to Alma Mater |

### Example SPV Database 124

TABLE 12A
SPV Details

| | | Date of | Expected | Primary | | Managing | Capital |
|---|---|---|---|---|---|---|---|
| Unique ID | Official Name | Establishment | Termination | Objective | Contact Info. | Entity | Structure |
| SPV-89101 | Crestview | 3 Mar. 2022 | 30 Apr. 2028 | Invest in | 123 Greenway | Crestview | Equity and |
| | Capital | | | renewable | Blvd, Solar | Management | Debt Mix |
| | Partners | | | energy | City, CA TEL | LLC | |
| | | | | projects | 555-123-4567 | | |

TABLE 12B
Private Equity Group Details

| | | | | | | Average |
|---|---|---|---|---|---|---|
| | | | | Linked SPV | Investment | Investment |
| Unique ID | Official Name | Contact Info | Address | ID | Focus | Size |
| EquityGroup- | Horizon Equity | connect@horizonequity.com | 456 Capital | SPV-89101 | SaaS and AI | $2M-$5M |
| DEF | Holdings | TEL: 555-123-4567 | Drive, | | Tech | |
| | | | Finance | | | |
| | | | Park, NY | | | |

TABLE 12C
Investor Details

| | | Investment | | Linked SPV | Investment | Investment | |
|---|---|---|---|---|---|---|---|
| Unique ID | Name | Amount | Contact Info | ID | Criteria | History | KYC Profile |
| Investor- | Lucas | $3,000,000 | 789 Investment | SPV-89101 | Long-term | Previous | Verified |
| C891 | Brown | | Lane, Market | | growth, Tech | investments | investor, |
| | | | City, TX Tel: | | sector focus | in TechStart | No adverse |
| | | | 999-123-4567 | | | Inc, | history |
| | | | | | | GreenTech | |
| | | | | | | Ltd | |

### Example SPV Database 124

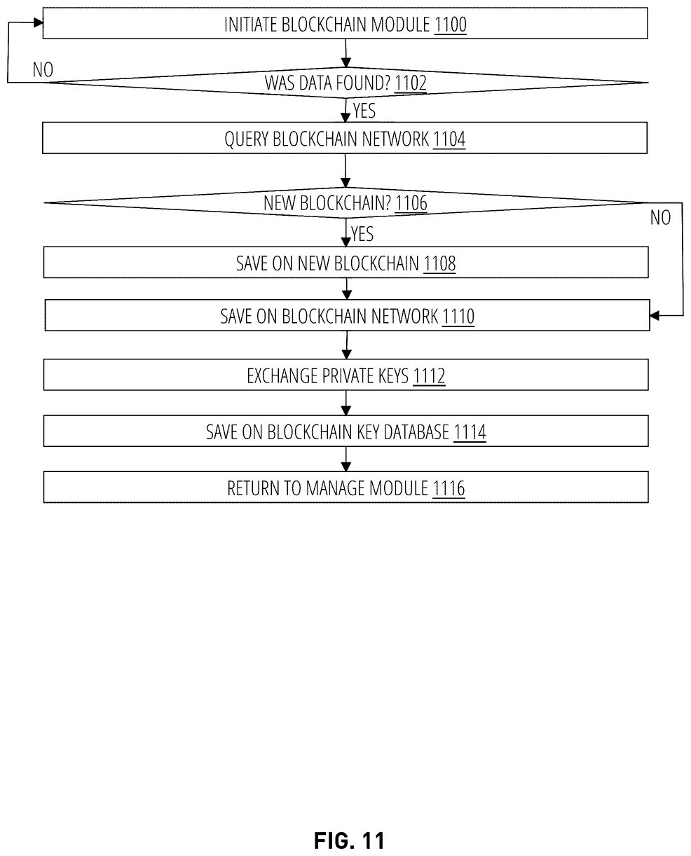

FIG. 11A

| SPV_Details | | | | |
|---|---|---|---|---|
| SPV_ID | SPV_Name | Creation_Date | Termination_Date | Objective |
| SPV-12345 | Golden Bridge Ventures | Jan. 1, 2022 | 31 Dec. 2027 | Asset Securitization |
| SPV-12346 | Silver Stream Investments | Jan. 2, 2022 | 31 Jan. 2028 | Debt Financing |
| SPV-12347 | Bronze Beacon Holdings | 15 Jan. 2022 | 14 Jan. 2027 | Real Estate Investment |
| . . . | . . . | . . . | . . . | . . . |

FIG. 11B

| Equity_Group_Details | | | |
|---|---|---|---|
| EquityGroup_ID | Equity_Group_Name | Contact_Phone | Contact_Email |
| EquityGroup-XYZ | Capital Heights | (415) 123-4567 | contact@email.com |
| EquityGroup-ABC | Peak Ventures | (310) 765-4321 | peak@email.com |
| EquityGroup-DEF | Valley Investments | (212) 987-6543 | valleyinvest@email.com |
| . . . | . . . | . . . | . . . |

FIG. 11C

| Investor detail | | | | |
|---|---|---|---|---|
| Investor_ID | Investor_Name | Investment_Amount | Contact_Email | Contact_Phone |
| Investor-A456 | John Doe | $1,000,000 | johndoe@email.com | (408) 111-2222 |
| Investor-A457 | Jane Smith | $750,000 | janesmith@email.com | (408) 111-2223 |
| Investor-A458 | Alan Brown | $1,500,000 | alanbrown@email.com | (408) 111-2224 |
| . . . | . . . | . . . | . . . | . . . |

### Example SPV Database 124

The reverse co-investment SaaS platform 100 may further include a blockchain key database 125 that may contain but not be limited to information about cryptographic keys used to manage digital assets and access blockchain networks. These keys are essential for secure authentication and transaction signing, and their proper management may be crucial for maintaining the integrity of blockchain systems. It may include the participant identifier of those within the SaaS network, associated private and public key pairs, metadata such as the creation date of the keys, and access control mechanisms, which may determine how access to the private keys is managed. Additionally, a key rotation status may be included, which may indicate whether a key pair is currently active, archived, or undergoing a key rotation process.

Below is an example of a blockchain database 136.

| Participant | | | | | Key Rotation |
|---|---|---|---|---|---|
| Identifier | Private Key (Encrypted) | Public Key | Metadata | Access Controls | Status |
| UserA | EncryptedPrivateKey_UserA_1 | PublicKey_UserA_1 | Jan. 15, 2023 | Role-Based Access | Active |
| UserB | EncryptedPrivateKey_UserB_1 | PublicKey_UserB_1 | Feb. 20, 2023 | Multi-Factor Auth | Active |
| OrgX | EncryptedPrivateKey_OrgX_1 | PublicKey_OrgX_1 | Mar. 10, 2023 | Authentication | Archived |
| | | | | Token | |
| InvestorC | EncryptedPrivateKey_InvestorC_1 | PublicKey_InvestorC_1 | Apr. 5, 2023 | Role-Based Access | Active |

### Example Blockchain Database 136

The reverse co-investment SaaS platform 100 may further include the AI analytics database 127, which is established to store and manage the data outputs from the AI analytics module 121 in the Reverse Co-Investment Platform. This database might archive a range of AI-processed data. Examples of such data could include machine learning models that have been trained on historical investment data to predict future investment trends, correlations identified between user characteristics (like investment history and risk preferences) and specific types of deals, and outputs from large language models used to analyze and synthesize textual data from user interactions or market reports. The AI analytics database 127 is set up to provide a centralized resource of AI-derived information. This data can be accessed and utilized by various modules across the platform, including the KYC module 108 for refining investor profiling, the deal module 110 for more accurate deal recommendations, and the reports module 116 for generating insightful analytics-based reports.

The reverse co-investment SaaS platform 100 may further include a cloud 126, a network of remote servers that host all the modules necessary to facilitate investment transactions among all parties in the SaaS network 102. cloud 126 is a distributed network of computational and data storage resources which may be available and accessed from anywhere via the internet or by a local network. A cloud 126 accessible via the internet is generally referred to as a public Cloud, whereas a cloud 126 on a local network is generally referred to as a private Cloud. The cloud 126 may further be protected by encrypting data and requiring user investor authentication prior to accessing its resources. the cloud 126 may facilitate the development, deployment, and management of the platform's infrastructure, tools, and services, including those needed for running applications integral to the platform, like the AI analytics module 121. Additionally, the cloud 126 might implement robust security frameworks, including data encryption and user authentication protocols, to ensure the protection of sensitive data and maintain the integrity of the platform's transactions.

The reverse co-investment SaaS platform 100 may further include a third-party network 128 may be comprised of one or more external network resources or systems owned by another party that may be integrated into the SaaS network 102. For example, a third-party network may refer to credit scoring and identity verification for the AIA module 106. The closing module 114 may refer to a third-party network 128 for legal services to parties involved in the investment deal module 110 and/or reports module 116 or technology solutions such as developing software applications and storage for the deal database 122. A third-party network 128 provides access to specialized expertise/resources to improve the efficiency, effectiveness, and security of the SaaS network 102.

The reverse co-investment SaaS platform 100 may further include a user device 130 is a device that may be used by user investors to interact with the SaaS network 102. The user device 130 may be a computer, laptop, tablet, smartphone, or another type of electronic device. The user device 130 must be able to connect to the internet and access the SaaS network 102 and associated modules. The user device 130 must also be able to display information from the SaaS network 102, such as investment opportunities from the deal module 110 and other critical information from the chat module 118 and reports module 116. The User Device may include a camera that can be used to scan documents or take pictures, a microphone that can be used to record audio and a touch screen that may be used to interact with the SaaS network 102.

The reverse co-investment SaaS platform 100 may further include a client application 132 is a software application that may be used to access the SaaS network 102. The client application 132 may be installed on a user device 130, such as a computer, smartphone, or tablet. The client application 132 allows user investors to view investment opportunities via the deal module 110, access the SPV module 112, and track the performance of their investments via the report module 116 and chat module 118. The client application 132 may connect to the SaaS network 102, may offer user investor authentication protocols for user investors to access the SaaS network 102, may provide data security, may push notifications to user investors to alert them to important events such as new investments opportunities via the deal module 110 or changes to the status of their investments via the report module 116 and chat module 118. The client application 132 may provide investment analysis tools for personalization of the user investor experience by tailoring content and features to the user investor interests.

The reverse co-investment SaaS platform 100 may further include a blockchain network 134, which functions as a distinct and separate entity, operating with its own infrastructure and architecture within the framework of the SaaS network 102. It is not an integral part of the SaaS network 102 but operates independently with unique characteristics. This includes its separate infrastructure, comprising a decentralized network of nodes responsible for validating and recording transactions. The blockchain network 134 employs its own technology stack, designed to uphold the security, transparency, and immutability of data and transactions. Notably, it maintains a decentralized nature, devoid of central authority, with transaction validation distributed across multiple network nodes for enhanced redundancy and security.

While independent, it seamlessly integrates with the SaaS network 102 to provide specific functionalities, such as secure data storage and authentication. This integration allows the SaaS network 102 to harness the advantages of blockchain technology while delivering an enhanced user experience. The blockchain network excels in secure data storage, leveraging decentralized, tamper-resistant mechanisms. Nodes within this network play a vital role in upholding the blockchain's integrity by validating transactions and enforcing consensus rules. Known for transparency, blockchain networks offer publicly accessible transaction histories, fostering trust through independent verification. Within the SaaS network 102 context, the blockchain network 134 acts as an external resource, augmenting data security, transparency, and user authentication. Users primarily engage with the SaaS network 102 interfaces, while the blockchain network operates discreetly in the background, enriching the user experience. In summary, the blockchain network 134 and the SaaS network 102 represent distinct yet synergistically integrated components, collectively delivering a comprehensive and secure user experience.

The reverse co-investment SaaS platform 100 may further include a blockchain database 136, which may store transaction data and related information for the SaaS network 102. It may serve as a distributed ledger that maintains a secure and tamper-proof record of all transactions, enabling transparency, traceability, and immutability. Components of blockchain database 136 may include but not be limited to transaction data that may include details of each transaction, such as sender, receiver, amount, timestamp, and transaction type, and block data, which may include transactions that may be grouped into blocks, which contain a unique identifier, a timestamp, and a reference to the previous block, forming a chain of blocks, a consensus mechanism, such as proof-of-work or proof-of-stake, to ensure that all participants in the SaaS network 102 agree on the state of the ledger, advanced encryption and hashing algorithms which may be used to protect the integrity and confidentiality of the data stored in the blockchain.

The blockchain database 136 may provide a comprehensive and secure platform for managing investments and transactions, which may include storing transaction data related to deals from the deal database 122, including investment commitments, fund transfers, and profit distributions, tracking the creation and ownership of SPVs from the SPV database 124 ensuring proper governance and transparency in investment management, the blockchain database 136 may provide tamper-proof records of closing transactions, including investment allocations, fund flows, and profit distributions from the closing module 114. It may serve as a source of data for generating reports on investment performance, regulatory compliance, and transaction history from the reports module 116.

The blockchain database 136 may provide inherent immutability and cryptographic security to protect transaction data from unauthorized alterations or manipulation, transaction visibility on the blockchain allowing for transparent tracking of investment flows and ensuring accountability, a distributed ledger that may ensure data integrity, consistency and prevent data loss or corruption, auditability, and traceability to facilitate compliance with regulatory requirements and provide evidence of adherence to investment guidelines that may provide a foundation for building trust and confidence among investors, deal sponsors, and other stakeholders.

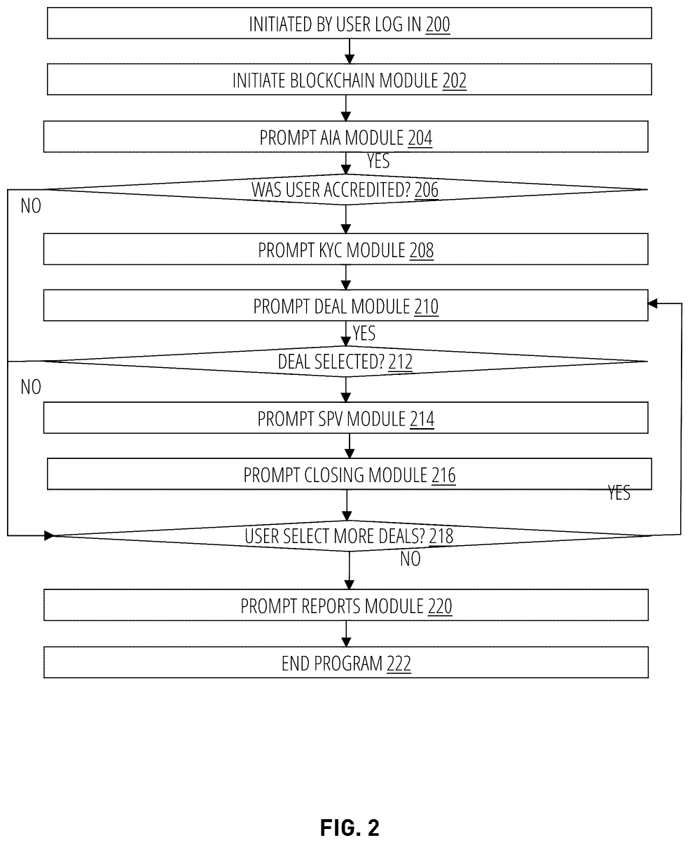

FIG. 2 illustrates an example method performed by a manage module.

The process begins with receiving a prompt at step 200 from the manage module 104. The blockchain module 119 may be initiated at step 202. The process of establishing a user's blockchain credentials for use on the SaaS network 102 may include a sequence involving cryptographic keys, which may include a private key(s) and public key(s). The process may be initiated by the user by registering an account on the SaaS network 102, which may include personal details and may require identity verification. The blockchain may be integrated into the SaaS network 102 authentication and user management systems to strengthen both security and transparency. As part of the blockchain authentication protocol, the user may initiate the generation of a private key or multiple keys, a unique cryptographic entity that may be securely generated and resides locally on the user's personal electronic device.

The user device may be a computer, tablet, or mobile device and the private key may be kept confidential and managed by the user individually, often through a secure digital wallet or hardware security module maintaining protection from unauthorized use. A single or multiple private key(s) may be associated with the user's identity on the blockchain and interactions within the SaaS network 102. Subsequently, public key(s) may originate from their private key(s), emerging as a distinctive identifier on the blockchain, which may be utilized for cryptographic validation while preserving the private key(s) inviolability. The private and public key(s) may be securely stored within the blockchain key database 125. serving as a reference point or pointer to their blockchain identity without enabling direct access to the blockchain itself.

When the user wishes to access the blockchain-driven features or modules on the SaaS network 102, they may be prompted at step 202 to initiate the blockchain login by the use of their private key, a critical component of blockchain authentication. The SaaS network 102 may provide the role of the private key verifier, cross-referencing the user's submitted private key with the corresponding public key, which may be stored within the blockchain key database 128. This precise verification process ensures a seamless match, paving the user's path to the blockchain features and SaaS network 102 modules. Within this blockchain, the user may conduct secure, authenticated transactions using their private key(s) as a digital tool to perform various actions, from signing documents to endorsing agreements, all bolstered by cryptographic verification. As the user investor's tasks approach completion, a critical step may include a secure logout from both the blockchain authentication process and the SaaS network 102.

Safeguarding the private key(s) confidentiality remains paramount to prevent unauthorized access to the user's blockchain identity and associated data. This carefully orchestrated process constructs a robust bridge to access blockchain-powered features on the SaaS network 102, where security and trust seamlessly converge. For example, Alice, an individual investor, decides to join the SaaS network 102 to explore investment opportunities on the network. She begins by registering her account, providing her personal details, and completing the identity verification process as part of user registration. As part of the registration process, Alice initiates the generation of her private key, a unique cryptographic entity, on her secure mobile device, which she uses for her blockchain interactions. Upon completion of her registration, Alice's private key is securely generated and stored locally on her mobile device. This private key remains confidential and under her sole control, typically within a secure digital wallet app. A corresponding public key may be derived from her private key and recorded as a distinctive identifier on the blockchain, ensuring her cryptographic validation while preserving the confidentiality of her private key.

When Alice wishes to access blockchain-driven features on the SaaS network 102, she is prompted to initiate the blockchain login by using her private key. The SaaS network 102 acts as the private key verifier, cross-referencing the private key she submits with the corresponding public key stored within the blockchain key database 128. This precise verification process seamlessly grants Alice access to the blockchain features and SaaS network 102 modules. Within the blockchain, Alice can securely perform various actions using her private key, such as signing investment agreements and endorsing deals, all backed by cryptographic verification. To complete her session securely, Alice logs out from both the blockchain authentication process and the SaaS network 102, safeguarding the confidentiality of her private key to prevent unauthorized access to her blockchain identity and associated data.

Another example may include an institutional investor, XYZ Corporation, who may wish to leverage the blockchain-powered features within the SaaS network 102 to streamline its investment processes. The corporation registers an institutional account on the SaaS network 102, providing the necessary corporate details and undergoing identity verification. As part of the registration process, XYZ Corporation initiates the generation of multiple private keys, each associated with different authorized personnel within the organization. These private keys are securely generated and stored within hardware security modules (HSMs) maintained by the corporation to ensure the highest level of security. Corresponding public keys are derived from these private keys and recorded on the blockchain, linking each key to the respective authorized personnel.

When individuals from XYZ Corporation need to access blockchain features on the SaaS network 102, they are prompted to initiate the blockchain login by using their private keys, which are managed and protected by the corporation's HSMs. The SaaS network 102 serves as the private key verifier, verifying the submitted private keys against the corresponding public keys stored within the blockchain key database 128. This precise verification process may grant authorized personnel access to the blockchain features and SaaS network 102 modules, allowing them to securely conduct various investment-related actions.

At the end of each session, individuals securely log out from both the blockchain authentication process and the SaaS network 102, maintaining the confidentiality of their private keys to prevent unauthorized access to XYZ Corporation's blockchain identity and sensitive data. The AIA module 106 may be prompted at step 204. The SaaS network 102 may verify the user-provided private key(s) against the corresponding public key(s) stored within the blockchain key database 128, ensuring an exact match. This blockchain authentication process occurs transparently and securely in the background. Upon successful verification, the investor may gain access to the AIA module 106.

The investor may access the AIA module 106, which may collect information such as net worth, income, occupation, and investment experience. The AIA module 106 may request information from a user investor, including name, address, email address, net worth, SS number, age, occupation, annual income, investment goals, financial situation, which may be used to accredit the user for access to the SaaS network 102 and to match the user investor with suitable investment opportunities. The AIA module 106 may render a decision about the accreditation for a user investor by using a variety of factors that may include investment experience, investment goals, risk tolerance, financial situation, employment status, and credit history. The AIA module 106 may use a scoring system to render a decision about the accreditation of a user investor. The score may be based on factors that are considered by the AIA module 106. For example, if the score meets the prescribed threshold, the user investor may be accredited and granted access to the SaaS network 102.

If the score does not meet the prescribed threshold, the user investor may not be accredited and denied access to the SaaS network 102. The AIA module 106 may be a software module that may receive and process data input from the user(s). The AIA module 106 may validate user-provided data. For example, John Smith is a 55-year-old individual who is interested in investing in early-stage startups. Mr. Smith is interested in becoming an accredited investor in the SaaS network 102. To begin the accreditation process, Mr. Smith provides information in the AIA module 106, which may include his financial status, investment experience, and education. The AIA module 106 may use algorithms, historical data, and predictive analytics to render a decision on the accreditation status of the user investor. In this example, the AIA module 106 threshold criteria may include an income test of at least $200,000 for the past two consecutive years of full employment with a net worth test of at least $1 million, excluding the value of a primary residence. Mr. Smith is fully employed and has an annual income of $350,000 per year for the past 5 years, with a net worth of $3 million. The AIA module 106 may render a decision to accredit Mr. Smith, who may now access the SaaS network 102.

After the user investor interacts with the AIA module 106, their data may be saved to the blockchain network 134 in a secure and immutable manner. The user investor may use their private key(s), which serves as their unique cryptographic access key, to securely access, manage, and authorize transactions related to their data on the blockchain network 134. The user investor private key(s) are essentially digital signature that confirms the user's identity and ensures the confidentiality and integrity of their interactions with the blockchain for access to the AIA module 106. It may be determined at decision block 206 if the user was accredited by the AIA module 106. If approved, the investor will be notified as an accredited investor at decision block 206 and now considered a user investor in the SaaS network 102. If the AIA module 106 does not accredit the investor, the process moves to step 222.

The KYC module 108 may be prompted at step 208 to create a know-your-customer (KYC) profile. The SaaS network 102 may verify the user-provided private key(s) against the corresponding public key(s) stored within the blockchain key database 128, ensuring an exact match. This blockchain authentication process occurs transparently and securely in the background. Upon successful verification, the investor may gain access to the KYC module 108. The user investor may be prompted to provide information that may include investment goals, risk tolerance, psychological profile, and associated financial resources. After providing the information for the KYC module 108, the information may be verified by the KYC module 108 and create a KYC profile for the user investor. The KYC profile information may be used to assist with matching deals with the specific profile of the user investor. While this information may be initially collected and processed within the SaaS network 102, when saved, the blockchain technology is seamlessly integrated to fortify the security and trustworthiness of this process.

The blockchain ensures that the user's KYC profile is securely stored and remains immutable, rendering it impervious to tampering or unauthorized alterations. Additionally, the blockchain, in conjunction with the KYC module 108, may employ various fraud detection techniques, such as monitoring the user's IP address, device, and behavior patterns cross-referencing them with the immutable data. This fusion of blockchain and KYC processes not only enhances data security but may also facilitate user authentication and enable the identification of potential fraudulent activity. Furthermore, the KYC profile information stored on the blockchain may be leveraged to match investment opportunities with the specific profile of the user investor, ensuring a tailored and suitable investment experience. The blockchain reinforces the security and trustworthiness of user investor data, ultimately contributing to a robust and trusted KYC process within the SaaS network 102. The deal module 110 may be prompted at step 210 to present deals to a user investor.

The SaaS network 102 may verify the user-provided private key(s) against the corresponding public key(s) stored within the blockchain key database 128, ensuring an exact match. This blockchain authentication process occurs transparently and securely in the background. Upon successful verification, the investor may gain access to the deal module 110. Once accessing the deal module 110, the user investor may benefit from a personalized investment experience driven by blockchain technology. The KYC profile, securely stored on the blockchain, serves as a guiding reference, assisting in identifying deals within the deal module 110 that may align closely with the user investor's specific investment preferences, risk tolerance, and other associated factors. The presentation of deal components, including order and content, may be customized dynamically based on the user investor's KYC profile parameters, creating a tailored and efficient interface for the user investor.

The deal module 110 may leverage a spectrum of factors and data, including past investment activity and location, to further refine deal matching. For instance, if a user investor has previously expressed interest in a particular industry, such as manufacturing, the deal module 110 may prioritize deals within that sector. Geographical relevance may also be taken into consideration, ensuring that deals align with the user investor's location. Additionally, budget and risk tolerance, derived from the user investor KYC profile, may be considered to gauge the suitability of each deal. By combining blockchain's robust authentication with personalized deal matching, the user investor is ensured a secure and user-centric investment experience. As a result, the deal module 110 provides a sophisticated and trusted platform for user investors to explore investment opportunities that best align with their financial goals and risk preferences.

Additionally, the deal module 110 may offer comprehensive information about each deal as new information may be made available, empowering user investors to make well-informed decisions about their investments. It may be determined at step 212 if the user investor has selected a deal after the deal module 110 has matched specific deals for the user investor. The blockchain authentication process may verify the user's identity using their private key(s), securely stored on the blockchain, and match it to the corresponding public key(s) in the blockchain key database 128, ensuring a precise and secure match. The user investor may either select a deal from the deal module 110 or reject a deal from the deal module 110. If the user investor selects a deal, the blockchain securely records this confirmation as an immutable and verifiable transaction, further enhancing trust and transparency. The user investor may then proceed to step 214, prompting the SPV module 112. If the deal is not selected at step 210, the process proceeds to end the program at step 222. The reverse co-investment SaaS platform 100 may further include the user investor selecting a deal by clicking on it or by entering its number, by ranking or filtering the deals based on their specific criteria, which may include the amount of investment or risk profile. This robust integration of blockchain technology ensures that the deal selection process is not only tailored to the user's preferences but also conducted with the utmost security and reliability, a vital feature within the SaaS network 102.

Once the user has selected a deal, they may then proceed to prompt the gift module 123. If the deal is not selected, the process proceeds to end the program. The reverse co-investment SaaS platform 100 may further include the user investor selecting a deal by clicking on it or by entering its number by ranking or filtering the deals based on their specific criteria, which may include the amount of investment or risk profile. It may be determined if the user investor has selected the gift module 123. Upon selection of the gift module 123 by the user investor, a systematic and secure process is initiated. The user may first undergo authentication to ensure secure access and appropriate permissions for using the gift module 123. Once authenticated, the user may be presented with an interface to initiate a gift transaction, where they may specify the asset type, quantity, and recipient details. The gift module 123 may conduct verification and compliance checks to validate the recipient's information and ensure the transaction adheres to relevant regulations and SaaS network 102 policies. Following successful verification, the gift module 123 may facilitate SPV module 112.

Essential information such as the nature, value, and involved parties of the gift, along with the transaction date, may be automatically transferred to the SPV module 112. This module then may meticulously log these details, ensuring accurate tracking and management of the SPV's assets and activities and may then record the gift details and documentation on the SPV database 124. The gift module 123 may conduct necessary compliance and verification checks to align the gift with legal, regulatory, and SPV-specific requirements. Following the successful recording, confirmations and notifications may be dispatched to relevant stakeholders, including donors and recipients, to update them on the SPV's status. Additionally, the gift module 123 may update its reporting and analytics features to reflect the new transaction, providing a transparent and updated view of the SPV's financial and operational standing. This streamlined process is crucial for maintaining the integrity and transparency of both the gift module 123 and SPV operations within the SaaS network 102.

The SPV module 112 may be initiated at step 214 after a deal is selected. The user investor, having been previously validated and accredited, possesses a unique private key(s) associated with their blockchain identity. To access the SPV module 112, the user investor may provide their private key(s), which acts as a cryptographic access key. This private key(s) may serve as proof of user investor identity and authorization, ensuring that only the legitimate user investor can interact with the SPV module 112. The private key(s) may be used to sign transactions and secure access to various functionalities within the blockchain network 134. Once the user investor's private key is successfully verified against the corresponding public key(s) stored on the blockchain key database 128, access to the SPV module 112 is granted. The user investor may then engage in actions related to the creation, management, and dissolution of the SPV as part of their investment process. The SPV module 112 may create the framework for a legal entity to hold the assets and liabilities of the selected investment from the user investor and the deal provider.

The SPV module 112 may be funded by raising money from user investor(s) who would be the owners of the SPV and may share in the profits or losses of the deal. The SPV module 112 may acquire the assets associated with the deal in the deal module 110. The SPV module 112 may sell the assets associated with the deal in the deal module 110. Once the assets have been sold, the SPV 112 may be dissolved. The SPV module 112 may be a software module that is implemented on a computer system and may create the framework for a separate legal entity that is created to manage the SPV. The SPV's legal structure and documentation are not directly saved on the blockchain. Instead, the blockchain primarily focuses on ensuring the security, transparency, and integrity of data and transactions related to the SPV, which may include ownership and financial details. Certain information about the SPV, such as its ownership structure and specific details, may be recorded on the blockchain as a reference or cryptographic hash. These are fundamental tools in cybersecurity and data verification, providing a secure and efficient means of ensuring data integrity and authenticity. This enhances transparency and traceability, but the bulk of the SPV's legal documentation, contracts, and agreements are typically managed and stored outside the blockchain, often in accordance with relevant legal and regulatory requirements.

The SPV module 112 may be managed by a third-party network 128. An embodiment for the SPV module 112 may include a unique deal type, for example, a real estate deal that may involve the use of a specific software module, while a venture capital deal may involve the use of a separate legal entity. The closing module 114 may be prompted at step 216 to initiate the closing process. The closing process may involve the transfer of funds and the signing of documents. The closing module 114 may create the documentation, terms, and conditions necessary to close the deal and send out a notification to all parties involved in the deal via the chat module 118. The closing module 114 may coordinate the closing process by ensuring the necessary documents are in place and that parties are present at the closing. The closing module may provide an identification process of the parties and may facilitate signatures on the necessary documents. If the deal does not successfully close due to regulatory restrictions, the user investor may be notified of such restrictions, and the investment may not be completed. The closing module 114 may use the blockchain to ensure the security, transparency, and integrity of the closing process.

It may store cryptographic references or hashes of the critical closing documents, creating an immutable record of these agreements on the blockchain network 134. This feature may enhance trust and transparency, as all involved parties may independently verify the authenticity and content of these documents through the blockchain. The closing module 114 may identify the parties involved in the transaction, often involving know-your-customer (KYC) and anti-money laundering (AML) checks to comply with regulatory requirements. The closing module 114 may collaborate with third-party legal services to draft and validate the necessary documentation and ensure compliance with relevant government regulations and laws. The blockchain may provide an immutable record of these legal processes, further enhancing the transparency and trustworthiness of the transaction. It may be determined at decision block 218 if the user investor has selected more deal(s). If the user investor selects another deal, the process returns to step 210. An embodiment may enable the user investor to select multiple deals at once or request additional information about a deal(s). The reports module 116 may be prompted at step 220 to generate reports on the deals that the user investor has selected. The user investor, having been previously validated and accredited, possesses a unique private key(s) associated with their blockchain identity.

To access the reports module 116, the user investor may provide their private key(s), which acts as a cryptographic access key. This private key(s) may serve as proof of user investor identity and authorization, ensuring that only the legitimate user investor can interact with the report module 116. Once the user investor's private key(s) is successfully verified against the corresponding public key(s) stored on the blockchain key database 128, access to the report module 116 may be granted. The blockchain's role in this process is primarily to provide secure and immutable storage for the underlying data contained in the report(s). As the reports module 116 compiles information on deals, it may hash or reference this data and store it on the blockchain network 134. These cryptographic references ensure the integrity and authenticity of the reports, preventing unauthorized modifications or tampering. The reports module 116 may generate a variety of reports, including, but not limited to, deal summary reports, including key information about the deals in deal module 110, such as the type of deal, the amount of money involved, and the terms of the deal. The reports module 116 may provide reports such as the financial risk, legal risk, tax-related documents, and associated regulatory and compliance reports. The user investor may be able to view and download this documentation. The reverse co-investment SaaS platform 100 may further include the reports module 116, generating reports based on the user investor criteria. For example, If Mr. Smith has invested in deals in the healthcare sector, he may request a report on all deals that are in the healthcare sector or a report on all deals that have a certain risk level in the healthcare sector.

The reverse co-investment SaaS platform 100 may further include generating a report on the return on investment for all deals that the user investor has invested in over a specific time period or real-time reporting capabilities with instant results for areas including financial performance. The report module 116 may use a third-party accounting firm to prepare the investment report, the financial statements, and the tax returns and comply with all applicable laws and regulations. Step 222 marks the end of the program. The program may end for a variety of reasons, including but not limited to the user investor completing all required tasks or if the user investor has encountered an error and has decided to exit the program.

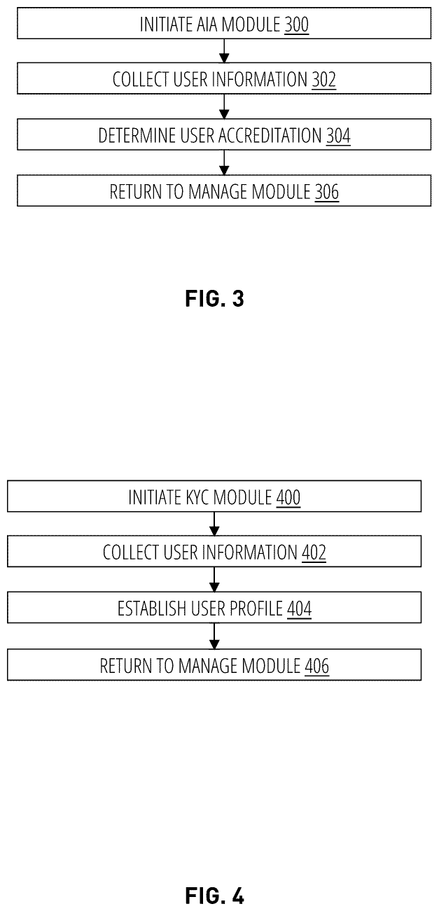

FIG. 3 illustrates an example method performed by an AIA module.

The AIA module 106 may be initiated at step 300 by the manage module 104. The AIA module 106 may collect user investor information at step 302 which may include information relating to income, assets, and net worth that may establish accreditation of the user investor necessary to access the SaaS network 102. The AIA module 106 may render a determination of user accreditation from user provided information at step 304.

The AIA module 106 may request additional information to determine whether the user meets established criteria for accredited investor status. The AIA module 106 may apply criteria to determine whether the user is accredited or fails to meet the accreditation criteria threshold. If the user meets the criteria for accredited investor status, the AIA module 106 returns a status of “accredited” and is considered a user investor with access to the SaaS network 102. If the user does not meet the criteria for accredited investor status, the AIA module 106 returns a status of “not accredited,” and the user is not allowed access to the SaaS network 102.

Embodiments to AIA module 106 may include resources to learn more about the accreditation process. The reverse co-investment SaaS platform 100 may further include the AIA module 106 implemented as a Cloud-based service for user submitted investment information or may include the AIA module 106 implemented as a software application that runs on the user's computer. The user may install the software application and submit their investment information to the application, which then evaluates the information and returns a status of “accredited” or “not Accredited.” The AIA module 106 may initiate a review process that may include verifying a user investor's financial data and may require additional information, including bank statements, investment account statements, and tax returns.

The AIA module 106 may use algorithms, historical data, and predictive analytics to decide on a user investor's accreditation status. When investing in private deals, individuals may need to demonstrate a certain level of financial sophistication and accreditation to participate in these types of investments. Accredited investor status is not a traditional accreditation like the CPA or CFA, but it's a regulatory classification used in the United States to determine eligibility for certain private investment opportunities. To qualify as an accredited investor, an individual typically needs to meet specific income or net worth criteria as defined by the U.S. Securities and Exchange Commission (SEC). One common requirement is having an annual income of at least $200,000 ($300,000 for married couples filing jointly) or a net worth of at least $1 million, excluding the value of their primary residence. Accredited investors are allowed to participate in private placements, hedge funds, and other investment opportunities that may not be available to non-accredited individuals.

The AIA module 106 may also determine investor accreditation by professional experience, background, and expertise rather than, or in addition to, income or net worth. For example, the AIA module 106 may collect information related to the investor's history of employment in the financial industry, relevant certifications, or prior participation in similar investment opportunities. The AIA module 106 may assess the investor's responses against predetermined criteria and benchmarks, such as a minimum number of years of experience in a specific financial role or the possession of specific professional certifications.

If the investor meets these criteria, the AIA module 106 may grant accredited investor status for the given investment, thereby allowing them to participate. This innovative approach broadens the pool of potential accredited investors, enhancing diversity and expertise within the SaaS network 102 and aligning with the financial industry's evolving landscape of investor accreditation criteria. If the user investor is accredited, the AIA module 106 may return the user investor to the Manage module 104 at step 306. If the user is not accredited, the user investor may provide additional information to the AIA module 106 to meet the accreditation threshold.

In some cases, when there is a blockchain module 119 the process may with the AIA module 106 may be initiated at step 300 by the manage module 104. The blockchain module 119 may be initiated. The SaaS network 102 may verify the user-provided private key(s) against the corresponding public key(s) stored within the blockchain key database 125, ensuring an exact match. This blockchain authentication process occurs transparently and securely in the background. Upon successful verification, the investor may gain access to the AIA module 106.

The AIA module 106 may be prompted. The user investor may access the AIA module 106, which may collect information such as net worth, income, occupation, and investment experience. The AIA module 106 may request information from a user investor, including name, address, email address, net worth, SS number, age, occupation, annual income, investment goals, financial situation, which may be used to accredit the user for access to the SaaS network 102 and to match the user investor with suitable investment opportunities. The AIA module 106 may render a decision about the accreditation for a user investor by using a variety of factors that may include investment experience, investment goals, risk tolerance, financial situation, employment status, and credit history.

The AIA module 106 may use a scoring system to render a decision about the accreditation of a user investor. The score may be based on factors that are considered by the AIA module 106. For example, if the score meets the prescribed threshold, the user investor may be accredited and granted access to the SaaS network 102. If the score does not meet the prescribed threshold, the user investor may not be accredited and denied access to the SaaS network 102. The AIA module 106 may be a software module that may receive and process data input from the user(s). The AIA module 106 may validate user-provided data.

For example, John Smith is a 55-year-old individual who is interested in investing in early-stage startups. Mr. Smith is interested in becoming an accredited investor in the SaaS network 102. To begin the accreditation process, Mr. Smith provides information in the AIA module 106, which may include his financial status, investment experience, and education. The AIA module 106 may use algorithms, historical data, and predictive analytics to render a decision on the accreditation status of the user investor. In this example, the AIA module 106 threshold criteria may include an income test of at least $200,000 for the past two consecutive years of full employment with a net worth test of at least $1 million, excluding the value of a primary residence.

Mr. Smith is fully employed and has an annual income of $350,000 per year for the past 5 years, with a net worth of $3 million. After the user investor interacts with the AIA module 106, their data may be saved to the blockchain network 134 in a secure and immutable manner. The user investor may use their private key(s), which serves as their unique cryptographic access key, to securely access, manage, and authorize transactions related to their data on the blockchain network 134. The user investor private key(s) are essentially digital signature that confirms the user's identity and ensures the confidentiality and integrity of their interactions with the blockchain for access to the AIA module 106. The AIA Module 106 may render a determination of user accreditation from user-provided information.

The AIA module 106 may request additional information to determine whether the user meets established criteria for accredited investor status. The AIA Module 106 may apply criteria to determine whether the user is accredited or fails to meet the accreditation criteria threshold. If the user meets the criteria for accredited investor status, the AIA Module 106 returns a status of “accredited” and is considered a user investor with access to the SaaS network 102. If the user does not meet the criteria for accredited investor status, the AIA Module 106 returns a status of “not accredited,” and the user is not allowed access to the SaaS network 102. Embodiments to AIA module 106 may include resources to learn more about the accreditation process. The AIA module 106 may initiate a review process, which may include verifying a user investor's financial data and may require additional information that may include bank statements, investment account statements, and tax returns. The AIA module 106 may use algorithms, historical data, and predictive analytics to render a decision on the accreditation status of a user investor. As a working example, Mr. Smith is interested in investing in startup companies seeking to raise capital through the SaaS network 102.

Smith's annual income is $350,000, he owns a primary home valued at $1.8 million and has a net worth of $3 million. The AIA module 106 threshold for an accredited investor may require a net worth of over $1 million and earnings over $200,000 in each of the past two years. It may be determined at step 308 if the user was accredited by the AIA module 106. In this example, the AIA module 106 approval threshold is met, and Mr. Smith is accredited and is now considered a user investor in the SaaS network 102. The blockchain module 119 may provide a continuous monitoring process designed to detect and respond to any relevant data changes or updates within the SaaS network 102, including changes in the user's accredited investor status.

Once the AIA module 106 confirms the user's accredited investor status, this data may trigger the blockchain module 119 to initiate the process of saving this information onto the blockchain network 134. The blockchain module 119 will assess the nature of the data, recognize that it pertains to the user's accreditation, and determine whether it should be integrated into the existing blockchain infrastructure or if it warrants the creation of a new blockchain segment, depending on the specific characteristics of the data. If the AIA module 106 does not accredit the investor, the program may end. If the user investor is accredited, the AIA module 106 may return the user investor to the manage module 104. If the user is not accredited, the user investor may provide additional information to the AIA module 106 to meet the accreditation threshold.

FIG. 4 illustrates an example method performed by a KYC module.

The KYC module 108 may be initiated at step 400 by the Manage module 104. The KYC module 108 may collect user information at step 402 to populate the KYC profile used in the SaaS network 102. The KYC module 108 may collect information from the user investor that may include the user investor's investment goals, risk tolerance, psychology profile, and financial resources to match the user investor with deals that are a good fit for the user investor. The KYC module 108 may utilize advanced data analytics and matching algorithms to match investment deals with user investors.

The KYC module 108 may collect comprehensive investor information that may consider attributes such as deal type, risk level, expected returns, geographic relevance, risk tolerance, investment horizon, and other preferences. These attributes may facilitate precise and efficient deal matching by aligning investor profiles with suitable investment opportunities. For example, the KYC module 108 may focus on matching a specific ESG (Environmental, Social, Governance) investment opportunity with a user investor who prioritizes sustainability.

In this example, the algorithm may assess the investor's ESG preferences by examining their KYC profile for values such as a commitment to renewable energy investments and carbon reduction goals. Simultaneously, the KYC module 108 may evaluate the attributes of available deals and may identify opportunities that align with the investor's ESG criteria, such as investments in solar energy projects with strong environmental initiatives. This example illustrates how the KYC module 108 may customize deal matching by identifying and prioritizing the specific values and priorities of an environmentally conscious user investor within the SaaS network 102. In this scenario, the KYC module 108 may search the demographic and geographical details of the user investor to create unique deal matches. Consider a user investor who recently relocated to a new city for a job opportunity.

The user investor's KYC profile may reflect this location change and identify a promising startup named “Local Growth Ventures” in the user investor's new city. Local Growth Ventures is focused on supporting and investing in businesses that significantly impact the local economy and community development. The KYC module 108 may be equipped with information about the user investor's new city location and demographic details, identifying the perfect synergy between the user investor's profile and Local Growth Ventures' mission to support local businesses. It may match the user investor to this deal, emphasizing the potential for investment in companies that align with the economic growth and development of the city the user investor now calls home.

This example illustrates how the KYC module 108 may leverage demographic and geographical data to create unique and location-specific investment matches, demonstrating the SaaS network 102's adaptability in accommodating investors' changing circumstances and providing them with investment opportunities that are tailored to their current situations. The KYC module 108 may establish the KYC profile for the user investor at step 404. The KYC profile may be used in the SaaS network 102. This profile might highlight, for example, a user's keen interest in agricultural tech startups based in South America. The KYC profile may include investment preferences including but not limited to industry sectors, geographic preferences such as East Asia or Northern Europe, record of past investments like a successful bet on a drone startup, types of deals preferred such as startups, real estate, M&A or even impact investing, portfolio diversification preferences, relevant professional experience or qualifications such as having a background in pharmaceuticals, and short and long-term investment objectives. Additionally, an investor might emphasize preferences for AI-driven education platforms.

The KYC profile may also include user investor preferred deal structures, for instance, equity over debt, economic and market trends that may influence investment decisions like a growing interest in the metaverse, social impact, and ESG investment considerations such as a tilt towards companies promoting gender equality, timing and exit preferences, personal interests or hobbies that may inform investment preferences like an avid interest in sustainable fishing that leans an investor towards ocean tech, and tax implications of investments and any specific tax-related preferences or requirements like seeking deals with potential for capital gains tax breaks. As a working example, Mr. Smith is interested in investing in technology companies seeking to raise capital through the SaaS network 102. The information provided by Mr. Smith may include his preference for a long-term investment with moderate risk, capital appreciation, and within his stated financial resources. The KYC profile identifies Mr. Smith as a sophisticated investor with a moderate risk tolerance.

In another illustration, Ms. Garcia's profile, derived from her inputs, could emphasize her background in the energy sector and her desire to diversify into sustainable energy projects. Consequently, a startup working on solar innovations might be suggested for her. The KYC module 108 may exclude high-risk speculative investments for Mr. Smith, for example, in the cryptocurrency sector or biotech firms working on unproven technologies. After the user investor provides the required information for the KYC module 108, the KYC profile may be established at step 406, and the KYC module 108 may return the user investor to the Manage module 104.

When there is a blockchain module 119, the process may begin with the KYC module 108 may be initiated aby the manage module 104. The blockchain module 119 may be initiated. The SaaS network 102 may verify the user-provided private key(s) against the corresponding public key(s) stored within the blockchain key database 125, ensuring an exact match. This blockchain authentication process occurs transparently and securely in the background. Upon successful verification, the investor may gain access to the KYC module 108.

For example, Susan, an individual investor, has been using the SaaS network 102 to manage her investments. She logs in to her account one day with the intention of updating her Know Your Customer (KYC) information, as required by regulatory compliance. Upon accessing her account, Alice is prompted to use her private key for blockchain authentication, ensuring the security of her account access. She provides her private key securely. In the background, the SaaS network 102 initiates the blockchain authentication process, verifying her private key against the corresponding public key stored within the blockchain key database 128. After successful blockchain authentication, Alice may gain access to the KYC module 108.

Within the KYC module, she can securely update her personal information, upload necessary identification documents, and complete any other required KYC procedures. These updates are securely recorded on the blockchain, ensuring transparency and immutability while complying with regulatory requirements. In another example, XYZ Capital, an institutional investor, regularly engages with the SaaS network 102 to manage its investment portfolio. Today, an important part of their investment process involves verifying legal documents related to a new investment opportunity.

One of XYZ Capital's compliance officers, James, logs in to the SaaS network 102 to access the KYC module 108 for document verification. As part of his login process, James uses his private key for blockchain authentication, ensuring that access to sensitive compliance-related functions is secure and authorized. In the background, the SaaS network 102 initiates the blockchain authentication process, confirming James's identity by verifying his private key against the corresponding public key stored within the blockchain key database 125. Upon successful blockchain authentication, James may gain access to the KYC module 108, where he may securely upload and verify legal documents associated with the investment opportunity. These document verification processes are recorded on the blockchain, providing an immutable audit trail that demonstrates compliance with regulatory and due diligence requirements.

In both examples, the blockchain authentication process serves to verify the user's private key against the corresponding public key stored within the blockchain key database 125. This secure authentication ensures that authorized users can access and interact with the KYC module 108, allowing them to update personal information or perform compliance-related tasks in a transparent and compliant manner. The KYC module 108 may collect user information to populate the KYC profile used in the SaaS network 102. The KYC module 108 may collect information from the user investor that may include the user investor's investment goals, risk tolerance, psychology profile, and financial resources to match the user investor with deals that are a good fit for the user investor. Know Your Customer (KYC) regulations are a vital component of financial and business operations, designed to prevent illicit activities like money laundering and fraud.

While there are international standards for KYC, specific criteria may vary between countries and regions. KYC modules may typically involve customer identification, risk assessment, ongoing monitoring, sanctions and Politically Exposed Persons (PEP) screening, beneficial ownership verification, and data privacy compliance. For example, in the United States, KYC regulations are primarily set at the federal level, but individual states may have additional requirements. Internationally, KYC requirements may vary from one country to another, with international organizations like the Financial Action Task Force (FATF) providing guidelines. Organizations may use specialized KYC software to adapt to different jurisdictions to ensure compliance. Legal guidance may be crucial for organizations operating in diverse regulatory environments, ensuring they meet KYC obligations effectively and securely. The KYC module 108 may utilize advanced data analytics and matching algorithms to match investment deals with user investors.

The KYC module 108 may collect comprehensive investor information that may consider attributes such as deal type, risk level, expected returns, geographic relevance, risk tolerance, investment horizon, and other preferences. These attributes may facilitate precise and efficient deal matching by aligning investor profiles with suitable investment opportunities. The KYC module 108 may implement a flexible KYC profile scrutiny framework that adapts to the specific attributes of each deal or transaction. This dynamic KYC process may consider factors such as transaction value, type, risk assessment, customer risk profile, regulatory requirements, beneficial ownership, and sanctions screening. For example, higher-value transactions or complex business deals may undergo more extensive KYC checks, while simpler commodity purchases may require less rigorous scrutiny.

This risk-based approach ensures that the KYC procedures align with the complexity and risk profile of each transaction, thereby enhancing regulatory compliance and risk mitigation. The KYC module 108 remains responsive to evolving regulatory standards and jurisdiction-specific requirements, offering a versatile solution for secure and compliant deal facilitation. For example, the KYC module 108 may focus on matching a specific ESG (Environmental, Social, Governance) investment opportunity with a user investor who prioritizes sustainability. In this example, the algorithm may assess the investor's ESG preferences by examining their KYC profile for values such as a commitment to renewable energy investments and carbon reduction goals. Simultaneously, the KYC module 108 may evaluate the attributes of available deals and may identify opportunities that align with the investor's ESG criteria, such as investments in solar energy projects with strong environmental initiatives.

This example illustrates how the KYC module 108 may customize deal matching by identifying and prioritizing the specific values and priorities of an environmentally conscious user investor within the SaaS network 102. In this scenario, the KYC module 108 may search the demographic and geographical details of the user investor to create unique deal matches. Consider a user investor who recently relocated to a new city for a job opportunity. The user investor's KYC profile may reflect this change in location and may identify a promising startup named “Local Growth Ventures” in the user investor's new city. Local Growth Ventures is focused on supporting and investing in businesses that have a significant impact on the local economy and community development. The KYC module 108 may be equipped with information about the user investor's new city location and demographic details, identifying the perfect synergy between the user investor profile and Local Growth Ventures' mission to support local businesses.

It may match the user investor to this deal, emphasizing the potential for investment in companies that align with the economic growth and development of the city the user investor now calls home. This example illustrates how the KYC module 108 may leverage demographic and geographical data to create unique and location-specific investment matches, demonstrating the SaaS network 102's adaptability in accommodating investors' changing circumstances and providing them with investment opportunities that are tailored to their current situations.

The blockchain module 119 may operate automatically and continuously, actively monitoring the KYC module 108 for any updates or changes in user investor data. This monitoring may occur seamlessly and in real-time, ensuring that the blockchain infrastructure remains up-to-date with the latest KYC information. When the KYC module 108 detects any modifications to a user investor's KYC data, such as changes in their risk tolerance, investment preferences, or personal information, it may send this updated information to the blockchain module 119, which may occur automatically, continuously and securely within the SaaS network 102.

Upon receiving the updated KYC data, the blockchain module 119 may initiate a series of actions, including verifying the authenticity and integrity of the incoming data to prevent any tampering or unauthorized changes. This verification process may employ cryptographic techniques to confirm the data's legitimacy. Once the data is verified, the blockchain module 119 may assess whether the update(s) warrant any changes to the blockchain structure. For example, if the KYC data pertains to a change in investment preferences or risk tolerance for a specific user investor, it may not necessitate a new blockchain segment.

In such cases, the module may seamlessly integrate the updated data into the existing blockchain ledger associated with that user investor. However, if the updates involve substantial changes, such as a modification in the user investor's accredited status or significant alterations in their KYC profile, the blockchain module 119 may determine that a new blockchain segment is required. In such instances, it may initiate the creation of a dedicated blockchain segment tailored to accommodate the unique attributes of the updated KYC data.

The KYC module 108 may establish the KYC profile for the user investor. The KYC profile may be used in the SaaS network 102. This profile might highlight, for example, a user's keen interest in agricultural tech startups based in South America. The KYC profile may include investment preferences including but not limited to industry sectors, geographic preferences such as East Asia or Northern Europe, record of past investments like a successful investment on a drone startup, types of deals preferred such as startups, real estate, M&A or even impact investing, portfolio diversification preferences, relevant professional experience or qualifications such as having a background in pharmaceuticals, and short and long-term investment objectives. Additionally, an investor might emphasize preferences for AI-driven education platforms.

The KYC profile may also include user investor preferred deal structures, for instance, equity over debt, economic and market trends that may influence investment decisions like a growing interest in the metaverse, social impact, and ESG investment considerations such as a tilt towards companies promoting gender equality, timing, and exit preferences, personal interests or hobbies that may inform investment preferences like an avid interest in sustainable fishing that leans an investor towards ocean tech, and tax implications of investments and any specific tax-related preferences or requirements like seeking deals with potential for capital gains tax breaks. As a working example, Mr. Smith is interested in investing in technology companies seeking to raise capital through the SaaS network 102. The information provided by Mr. Smith may include his preference for a long-term investment with moderate risk, capital appreciation, and within his stated financial resources.

The KYC profile may identify Mr. Smith as a sophisticated investor with a moderate risk tolerance. In another illustration, Ms. Garcia's profile, derived from her inputs, could emphasize her background in the energy sector and her desire to diversify into sustainable energy projects. Consequently, a startup working on solar innovations might be suggested for her. The KYC module 108 may exclude high-risk speculative investments for Mr. Smith, for example, in the cryptocurrency sector or biotech firms working on unproven technologies. In an exemplary embodiment, the present invention comprises a seamless and secure interaction between the KYC module 108 and the blockchain module 119 within a comprehensive KYC verification system. When an update to the KYC module 108 occurs, triggered by the addition or modification of customer information, a well-defined process is initiated. The updated KYC data is first subjected to encryption to ensure data confidentiality. Subsequently, the encrypted data is hashed using industry-standard cryptographic hash functions, creating a fixed-size hash value. A dedicated smart contract within the blockchain module 119, which defines access controls and data storage rules, may then be invoked.

A transaction may be generated, incorporating the hashed KYC data as a parameter, and this transaction may be committed to the blockchain network 134. Upon successful inclusion in a block, the KYC data update is considered securely stored on the blockchain, with its integrity assured through the cryptographic hash. Furthermore, the blockchain module 119 maintains a reference to the relevant customer profile within the KYC module 108, allowing for seamless retrieval and verification of KYC data when required. This interaction ensures a tamper-resistant and auditable record of KYC updates, safeguarding the integrity of the user investor information while providing authorized entities with efficient access to the most up-to-date KYC data in compliance with regulatory requirements and enhancing the transparency and security of KYC processes, mitigating risks associated with traditional centralized systems. After the user investor provides the required information for the KYC module 108, the KYC profile may be established, and the KYC module 108 may return the user investor to the manage module 104.

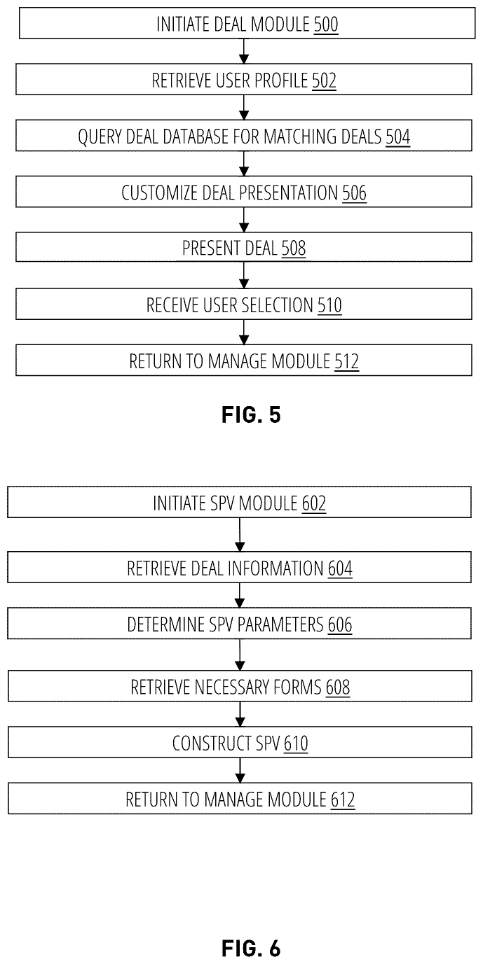

FIG. 5 illustrates an example method performed by a deal module.

The deal module 110 may be initiated at step 500 by the Manage module 104. The deal module 110 may be prompted at step 502 to retrieve the user investor KYC profile from the KYC module 108. The user investor KYC profile may provide user information that may include investment goals, risk tolerance, psychological profile, and associated financial information necessary to match deal(s) for the user investor in the deal module 110.

The deal database 122 may be queried at step 504 to match deals for the user investor in the SaaS network 102. The deal database 122 may contain information on potential investment opportunities, which may include a unique identifier of the deal, company name, industry category, and targeted investment amount. The user investor information in the KYC profile may be used to filter deals in the deal database 122. The user investor KYC profile may include information such as the investment stage, industry focus, and geographic preferences that may be used to identify deals that may be a good fit for the investor. The user investor may also specify specific deal criteria from the deal database 122, such as the deal size, the deal type, and the industry sector, which may be used to refine the list of potential matching deals that are returned in the deal module 110.

The reverse co-investment SaaS platform 100 may further include a deal matching algorithm to determine which deals are the best match for the user investor that may include the investor's profile, the deal criteria, and the specific characteristics of each deal that may identify top matching deals for the user investor. For example, John Smith's KYC profile may establish his preference for moderate risk investment(s).

Therefore, the deal module 110 may match Mr. Smith with a deal in the medical technology industry that offers a modest return outlook with relatively limited risk instead of a deal with an early-stage company in the AI technology sector that may offer high potential returns with extremely high risk. The deal module 110 may be prompted at step 506, which may manage the deal flow for the SaaS network 102 and customize deal presentation(s) to the user investor based on the user investor AIA module 106 and KYC profile in the KYC module 108.

The deal module 110 may personalize the deal presentation to the user investor by highlighting the aspects of the deal that are most likely to be of interest to the user investor. The deal module 110 may consider the user investor's investment strategy when customizing a deal presentation and priority listing. For example, if the user investor is primarily interested in early-stage companies, the deal module 110 may identify deals and highlight the startup company team, product, and market potential. If the user investor is focused on later-stage companies, the deal module 110 may focus on the company's market position, revenue growth, and profitability and present customized deal(s) to match these criteria. The deal module 110 may provide the user investor with information to make an informed decision about the deal, including the company's financial projections, market analysis, and competitive landscape. The deal presentation may include customized dashboards and real-time notifications to engage user investors.

The system may offer comprehensive deal presentation options with attributes such as asset class, risk level, expected returns, and investment horizon. User investors may have access to interactive visualizations and comparison tools for informed decision-making. These features may enhance the investor experience by presenting investment opportunities in a user-friendly and tailored manner. An example may include a renewable energy project matched to an environmentally conscious investor. In this example, the dashboard for the user investor may highlight a presentation section titled ‘ESG Opportunities,’ and a real-time notification may highlight a new solar farm expansion project aligned with the investor's ESG preferences. The user investor may be presented with a detailed deal overview, including information on the project's sustainability initiatives, community engagement, and expected carbon reduction. Interactive visualizations may enable the investor to explore projected energy output and financial forecasts, while a comparison tool may contrast this ESG investment with others. This example demonstrates how personalized presentation(s) may cater to specific values and preferences of the user investor, fostering a highly engaging and informed decision-making process.

The deal module 110 may also present deals based on financial parameters. For example, if the user investor has a budget of $250,000, the Deal module may display opportunities that align with his financial criteria. These opportunities may be presented in a user-friendly dashboard, providing key details such as the company's name, industry sector, required investment amount, and a brief description of the opportunity. The user investor may click on a specific deal to access comprehensive details, including financial projections, business plans, and the terms of the investment. Customizing the deal presentation in the deal module 110 for the user investor may address the diverse requirements of various user investors, make the investment process more efficient and effective, and increase the chances of the deal being funded in the SaaS network 102. It may be determined at step 508 that the user investor may be presented with a specific deal or deals from the deal module 110 that may match the user investor's investment criteria. The order and format in which deals are presented in the deal module 110 may be based on the user investor preferences. The deal module 110 may present deals in chronological order, with the most recently created deals appearing at the top of the list, allowing user investors to quickly identify new deals. The deal module 110 may present deals by status, with deals in the same status grouped together.

For example, user investors may focus on specific deals and deals at risk of closing within a specific time frame. The deal module 110 may present deals by type, such as software, hardware, or industry-specific deals. The deal module 110 may present deals in a list view, with basic information such as the deal name, customer name, and deal status. The deal module 110 may present deals in a table view with more detailed information, such as the deal amount, close date, and stage. It may be determined at step 510 that the user has selected a deal, and the deal module 110 may receive the user selection. Step 512 may be initiated after the user investor completes the deal selection and may be returned to the Manage module 104.

When there is a blockchain module 119, the process begins with the deal module 110 being initiated by the manage module 104. The blockchain module 119 may seamlessly interact with the deal module 110 within the SaaS network 102, providing a secure and transparent platform for managing and recording transactions and deals. When a deal or transaction is initiated within the deal module 110, the blockchain module 119 may facilitate various aspects of the process, which may include generating a unique and tamper-proof digital token or smart contract that encapsulates the deal's terms and conditions. This smart contract may be securely recorded on the blockchain network 134, which may be permissioned or public, thereby creating an immutable and auditable record of the deal.

Throughout the lifecycle of the deal, the blockchain module 119 may actively monitor and update the smart contract to reflect any changes or milestones that may be reached. This continuous synchronization may ensure that all parties involved have access to the most up-to-date and agreed-upon terms of the deal. The blockchain module 119 may leverage its consensus mechanism to validate and confirm the execution of key milestones, communication, or trigger events within the deal, providing an automated and trustless mechanism for deal execution. In the context of blockchain and smart contracts, “trustless” refers to the idea that participants in a deal or transaction do not need to trust a centralized authority, intermediary, or each other to ensure the fairness and integrity of the transaction. Instead, trust is established through the transparency and immutability of the blockchain ledger and the deterministic execution of smart contracts. Participants may rely on the code and the blockchain's decentralized nature to ensure that the terms of the deal will be executed as agreed upon, without the risk of fraud or manipulation.

In the event of disputes or discrepancies, the blockchain module 119 offers a transparent and immutable ledger of the deal's history, enabling a verifiable audit trail. Authorized participants in the deal module 110 may access this ledger to review and confirm the deal's progression and resolution. This innovative interaction between the blockchain module 119 and the deal module 110 may enhance the efficiency, security, and transparency of deal management within the SaaS network 102, offering significant advantages in various industries where deal integrity and trust are paramount. For example, A real estate corporation, XYZ Realty, utilizes the SaaS network 102 to streamline and secure a real estate-related deal within the deal module 110, specifying the terms and conditions.

The blockchain module 119 may generate a unique and tamper-proof smart contract that encapsulates the deal's terms and conditions, which may include contract details such as the purchase price, property description, and important milestones like the inspection and financing approval deadlines. The generated smart contract may be securely recorded on the blockchain network 134. This action creates an immutable and auditable record of the real estate deal where all relevant parties may have access to this blockchain ledger. Throughout the lifecycle of the deal, the blockchain module 119 may actively monitor and update the smart contract. For instance, when the buyer successfully completes the property inspection, this milestone may be recorded on the blockchain. Similarly, when the seller provides required disclosures, this information may be added to the smart contract.

The blockchain module 119 may leverage its consensus mechanism to validate and confirm the execution of key milestones. For example, when the buyer's financing is approved, the smart contract may automatically trigger the transfer of funds related to the deal. Parties to the deal may not have to rely on intermediaries or each other's trust. Instead, they trust the transparent and deterministic execution of the smart contract, backed by the blockchain's immutability. In the event of disputes or discrepancies, the blockchain module 119 may offer a transparent and immutable ledger of the deal's history. Authorized participants may access this ledger to review and confirm the deal's progression and resolution.

In another example, a multinational manufacturing company, XYZ Corp, may use the SaaS network 102 for managing its complex supply chain operations leveraging blockchain technology to ensure transparency and trust in their supply chain deals. For instance, XYZ Corp has an ongoing relationship with a key supplier, Supplier ABC. When a new shipment of critical components is ready for delivery, they initiate a supply chain deal within the deal module 110. The deal specifies the quantity, quality standards, and delivery timelines. The blockchain module 119 may generate a smart contract that encapsulates the deal's terms. This smart contract includes details such as the product specifications, pricing, and agreed-upon quality checks. The smart contract may be securely recorded on the permissioned blockchain network 134 used by XYZ Corp and its trusted suppliers. This creates an immutable and auditable record of the supply chain deal. As the components move through the supply chain, the blockchain module 119 may actively update the smart contract to reflect key events.

For example, when Supplier ABC completes a quality inspection and certifies the components' compliance, this information is added to the smart contract. The blockchain's consensus mechanism validates critical milestones, such as the successful loading of components onto shipping containers. This verification triggers automatic notifications to relevant parties and ensures that everyone is in sync. In case of discrepancies or disputes, XYZ Corp and Supplier ABC may access the blockchain ledger to review the complete history of the supply chain deal. In the operation of the blockchain module 119 in a situation where a user investor decides not to proceed with a deal or transaction in the deal module 110, no transaction is initiated or recorded on the blockchain. This means that the blockchain remains unchanged, and no data related to the deal is stored on it. The user's decision not to proceed effectively results in no blockchain activity regarding the deal. The deal module 110 may be prompted at step 504 to retrieve the user investor KYC profile from the KYC module 108.

The user investor KYC profile may provide user information that may include investment goals, risk tolerance, psychological profile, and associated financial information necessary to match deal(s) for the user investor in the deal module 110. The deal database 122 may be queried at step 504 to match deals for the user investor in the SaaS network 102. The deal database 122 may contain information on potential investment opportunities, which may include a unique identifier of the deal, company name, industry category, and targeted investment amount. The user investor information in the KYC profile may be used to filter deals in the deal database 122. The user investor KYC profile may include information such as the investment stage, industry focus, and geographic preferences that may be used to identify deals that may be a good fit for the investor. The user investor may also specify specific deal criteria from the deal database 122, such as the size of the deal, the type of deal, and the industry sector, which may be used to refine the list of potential matching deals that are returned in the deal module 110.

For example, a user investor may perform a keyword-based search, entering specific terms or phrases related to their investment preferences and criteria. The deal module 110 may then leverage these keywords as search parameters to query the deal database 122, which indexes and stores essential deal information. For instance, a user investor interested in technology startups may input keywords like ‘technology,’ ‘startup,’ and ‘innovation.’ The deal database 122 may respond by providing a list of deals that closely align with the specified keywords, which may allow user investors to efficiently identify relevant opportunities. The reverse co-investment SaaS platform 100 may further include a deal-matching algorithm to determine which deals may be the best match for the user investor. That may include the investor's profile, the deal criteria, and the specific characteristics of each deal that may identify top matching deals for the user investor, which may include industry sectors, geographic regions, investment size, risk tolerance, and return expectations. This comprehensive profile serves as input for the algorithm, which queries the deal database 122 to rank and prioritize available deals based on their alignment with the user's preferences. Factors such as industry sector overlap, geographic proximity, and financial metrics may be considered.

For example, a user specifying an interest in renewable energy projects within a specific region and investment size range may receive a list of deals ranked by their degree of alignment with these criteria, streamlining the process of identifying potential investments that match the user's unique profile. For example, John Smith KYC's profile may establish his preference for moderate risk investment(s). Therefore, the deal module 110 may match Mr. Smith with a deal in the medical technology industry that offers a modest return outlook with relatively limited risk instead of a deal with an early-stage company in the AI technology sector that may offer high potential returns with extremely high risk. The deal module 110 may be prompted at step 508, which may manage the deal flow for the SaaS network 102 and customize deal presentation(s) to the user investor based on the user investor AIA module 106 and KYC profile in the KYC module 108.

The deal module 110 may personalize the deal presentation to the user investor by highlighting the aspects of the deal that are most likely to be of interest to the user investor. The deal module 110 may consider the user investor's investment strategy when customizing a deal presentation and priority listing. For example, if the user investor is primarily interested in early-stage companies, the deal module 110 may identify deals and highlight the startup company team, product, and market potential. If the user investor is focused on later-stage companies, the deal module 110 may focus on the company's market position, revenue growth, and profitability and present customized deal(s) to match these criteria. The deal module 110 may provide the user investor information to make an informed decision about the deal, including the company's financial projections, market analysis, and competitive landscape.

For example, John Smith's KYC profile prioritizes his preference for low-risk as the primary factor in matching deals for consideration. The deal module 110 may present Mr. Smith with a deal in an executive summary format with a concise overview of the investment opportunity with a focus on the risk profile instead of a pitch deck presentation, which may present a primary focus on the deal business technology. The deal module 110 may utilize data analytics and machine learning algorithms to provide personalized deal recommendations to the user investor, which may consider their past investment activity, preferences, and behavior. This data may include their previous investments, industries of interest, risk tolerance, and historical deal engagement. Using this information, the deal module 110 may tailor the deal presentation by showcasing deals that are highly relevant to the user's investment history and preferences.

For example, if the user has a history of investing in technology startups, the deal module 110 may prioritize and prominently display technology-related startup deals. Additionally, the deal module 110 may suggest deals with similar risk profiles or potential returns based on the user's previous investment choices. The deal module 110 may also empower the user investor with the ability to customize how deals are presented and sorted based on their individual preferences by offering filtering and sorting options that allow them to refine the list of available deals according to their criteria. For example, the user investor may filter deals by industry sector, geographic location, investment size, risk level, or other relevant attributes, including deal size, expected returns, or the date of posting. By using these customization tools, the user investor may quickly narrow the list of deals to those that align with their specific investment objectives.

Additionally, the deal module 110 may provide the user investor with the ability to save their preferred filtering and sorting settings as default preferences so deals are presented according to their predefined criteria, enhancing the user experience and efficiency. Customizing the deal presentation in the deal module 110 for the user investor may make the investment process more efficient and effective and increase the chances of the deal being funded in the SaaS network 102. It may be determined at step 506 that the user investor may be presented with a specific deal or deals from the deal module 110 that may match the user investor's investment criteria. The order and format in which deals are presented in the deal module 110 may be based on the user investor preferences. The deal module 110 may present deals in chronological order, with the most recently created deals appearing at the top of the list, allowing user investors to quickly identify new deals. The deal module 110 may present deals by status, with deals in the same status grouped together.

For example, user investors may focus on specific types of deals, and deals that are at risk of closing within a specific time frame. The deal module 110 may present deals by type, such as software deals, hardware deals, or industry-specific deals. The deal module 110 may present deals in a list view, with basic information such as the deal name, customer name, and deal status. The deal module 110 may present deals in a table or grid view with more detailed information, such as the deal amount, close date, and stage. It may be determined at step 510 that the user has selected a deal, and the deal module 110 may receive the user selection. Step 512 may be initiated after the user investor completes the deal selection and may be returned to the manage module 104.

When there is an AI analytics module 121, the deal module 110 may be initiated by the manage module 104. The deal module 110 may be prompted to retrieve the user investor KYC profile from the KYC module 108. The user investor KYC profile may provide user information that may include investment goals, risk tolerance, psychological profile and associated financial information necessary to match deal(s) for the user investor in the deal module 110.

The deal module 110 may leverage the output from the AI analytics module 121 to enhance the deal selection and customization process. Utilizing the user investor's KYC profile data retrieved from the member database 120, the AI analytics module 121, through its continuous analysis of data from the deal database 122, provides insights and recommendations for deal alignment. One working example at this stage involves using cross-correlation techniques in the AI analytics module 121. Suppose the KYC profile indicates the user investor's preference for technology startups with an emphasis on sustainability. The AI module cross-correlates this preference with specific characteristics of deals in the deal database 122, such as startups' environmental impact scores, sustainable technology innovations, and carbon footprint reduction initiatives. If a high correlation coefficient, say 0.85, is found between these deal characteristics and the user's preference profile, the AI module flags these deals as highly relevant for presentation to the investor.

Another example of AI application at this step is through machine learning or large language models. If the KYC profile shows the user's interest in biotech firms focusing on genomics, the AI module applies a machine learning algorithm to identify biotech firms in the deal database 122 specializing in genomics. It then customizes the presentation of these deals, highlighting key aspects like their R&D advancements, patent portfolios, and potential for groundbreaking discoveries in genomics. These AI-driven processes may ensure that the deal module 110 can offer more personalized, relevant, and data-driven deal presentations to the user investor, significantly enhancing the platform's effectiveness in aligning investment opportunities with investor preferences. The deal module, armed with insights from the AI analytics module 121, may proceed to personalize the deal presentations for the user investor. This step is where the sophisticated analysis and machine learning insights are translated into actionable, user-specific deal recommendations.

For instance, if the AI analytics module 121 has identified through cross-correlation that the user investor has a strong inclination towards green technology startups, the deal module 110 at this step would prioritize deals involving companies with innovative green technologies, sustainable business practices, and a strong environmental impact record. The presentation of these deals would be tailored to highlight aspects most likely to resonate with the investor's interests, such as sustainability awards won by the company, its carbon-neutral initiatives, and its role in promoting green technology.

Alternatively, if the AI module has used machine learning algorithms to deduce the investor's interest in mature companies with stable revenue growth, the deal module 110 would customize the deal presentation to focus on companies' financial metrics, market growth trends, and stability indicators. This might include emphasizing the companies' consistent revenue growth over the years, their strong market positioning, and their long-term investment potential. Such a step is crucial as it ensures that the deals presented are not only aligned with the investor's preferences but are also displayed in a manner that is most engaging and informative for them. This personalized approach enhances the user experience and increases the likelihood of investment matches.

The deal module 110 may further present the AI-customized deals to the user investor. This is where the personalized recommendations and tailored presentations, developed in the previous steps, are actively displayed to the investor. The module showcases the selected deals, each finely tuned to align with the investor's specific interests and investment strategy as identified through the AI analytics module 121's analysis. The manner in which these deals are presented is key. It's not just about listing investment opportunities; it's about creating an engaging and informative experience.

For an investor interested in green technology, the presentation might include interactive elements such as graphical representations of environmental impact metrics or videos showcasing the technology in action. For an investor focused on financially stable companies, the presentation could include detailed financial charts, market trend analyses, and projections to provide a comprehensive understanding of each investment's potential. This step is vital in maintaining the investor's engagement and interest. By presenting the deals in a format that resonates with the investor's preferences and providing them with all the information they need to make an informed decision, the deal module 110 enhances the overall effectiveness of the investment matching process on the platform.

The user investor's selection may be received and the interactions of the user investor with the presented deals are meticulously recorded and analyzed. This step is critical for the continuous improvement and learning of the AI analytics module 121. The user's actions, whether they express interest in a particular deal, request more information, or choose to invest, are all valuable data points that feed back into the system. This feedback loop is essential for refining the AI algorithms and enhancing the precision of future deal presentations. For example, if a user consistently shows interest in deals with a strong sustainability component but has not yet made an investment, the AI module may adjust its parameters to present similar deals with more emphasis on financial stability or market growth potential. The data collected at this step also helps in evolving the user's KYC profile in the member database 120, ensuring that the evolving interests and preferences of the investor are accurately reflected in their profile for future interactions with the platform.

FIG. 6 illustrates an example method performed by an SPV module.

The SPV Module may be initiated at step 602 by the Manage module 104. The SPV Module may be prompted at step 604 to retrieve deal information from the deal module 110.

The blockchain module 119 may seamlessly integrate with the SPV module 112, offering a secure and transparent mechanism for recording and accessing essential information related to Special Purpose Vehicle at step 604. The SPV module 112 may serve as a repository for critical data associated with various investment vehicles, including details about ownership, asset portfolios, legal documentation, and financial performance. When updates or additions to SPV-related data occur within the SPV module 112, a structured process may be initiated by the blockchain module 119 to ensure the immutability and transparency of this information. The updated information, which may encompass changes in ownership, asset composition, or other pertinent details, is subjected to encryption and hashing to maintain data integrity and confidentiality. Once this data is securely prepared, the blockchain module 119 may orchestrate the creation of a dedicated digital token or smart contract representing the SPV and its associated data.

This smart contract may then be executed and committed to the blockchain network 134, resulting in an immutable and tamper-resistant record of the SPV's characteristics and ownership history securely stored on the blockchain network 134. Authorized entities within the SaaS network 102 may access this information, verify ownership, and audit the historical performance of SPVs. Furthermore, the blockchain module 119 may facilitate seamless updates and transfers of SPV ownership while ensuring the accuracy and security of the information recorded on the blockchain. This innovative interaction between the blockchain module 119 and the SPV module 112 enhances transparency, trust, and efficiency in managing and monitoring Special Purpose Vehicles, which may offer significant advantages in maintaining SPV data integrity. For example, XYZ Investment Firm is seeking a new investment deal within the deal module 110. A unique smart contract may be generated by the blockchain module 119 to encapsulate the deal's terms and securely recorded on the blockchain network 134. When the deal is approved, the SPV module 112 may form a Special Purpose Vehicle (SPV) dedicated to this investment. The blockchain module 119 may interface with the SPV module 112 to associate the newly formed SPV with the terms and conditions specified in the smart contract, ensuring seamless integration.

Multiple investors may participate in the deal, acquiring shares in the SPV, with their ownership recorded on the blockchain. Throughout the investment's lifecycle, the blockchain module 119 may actively monitor and update the smart contract to reflect changes or milestones achieved. Returns are distributed automatically and transparently through the SPV based on the smart contract terms, while the blockchain ensures an immutable audit trail. Investors may access real-time information about the SPV's performance and financial status, enhancing trust and efficiency in investment fund management. In another example, Jane, an individual user investor, may be interested in diversifying her investment portfolio across various asset classes. She logs into her account on the SaaS network 102, which provides her access to a range of investment opportunities, from startups to established businesses. Jane identifies an appealing startup, TechStartup Inc., in which she wants to invest. She initiates the investment process within the deal module 110, specifying her investment amount and desired equity stake.

The blockchain module 119 seamlessly generates a smart contract tailored to Jane's investment in TechStartup Inc. This smart contract captures all terms and conditions of the investment, including equity shares, funding amount, and any profit-sharing arrangements. The contract is securely recorded on the blockchain network 134, creating an immutable record of Jane's investment commitment. In this case, an SPV known as “InvestorSPV” is formed through the SPV module 112. The purpose of InvestorSPV is to pool the investments of individual investors like Jane and efficiently manage their collective interests in TechStartup Inc. The blockchain module interfaces seamlessly with the SPV module, ensuring that InvestorSPV is associated with the terms outlined in Jane's smart contract. This integration guarantees that Jane's investment is accurately represented within the SPV structure. Jane's investment in TechStartup Inc. becomes part of InvestorSPV. Other individual investors may also contribute, with their investments recorded transparently on the blockchain through the SPV module 112.

Throughout TechStartup Inc.'s journey, the blockchain module 119 may actively monitor and update the smart contract to reflect key milestones and developments. For example, when TechStartup Inc. achieves a significant funding round or reaches a revenue milestone, these events are recorded on the blockchain. When TechStartup Inc. generates profits or dividends, these are distributed automatically to InvestorSPV, and individual investors like Jane receive their proportional share based on their smart contract terms. The blockchain ledger ensures transparency and auditability, and Jane may access real-time reports, view the progress of her investment, and review the immutable history of TechStartup Inc.'s performance and profit distributions. This innovative interaction enhances the investment experience for individual user investors while providing them with the security and trust offered by blockchain technology. The SPV module may be prompted at step 606 to retrieve deal information from the deal module 110. The user investor deal information may include customized deal information on certain deal opportunities, which may include the unique identifier of the deal, company name, industry category, and targeted investment amount.

The user investor deal information may include customized deal information on certain deal opportunities, which may include a unique identifier of the deal, company name, industry category, and targeted investment amount. The SPV parameters may be determined at step 606, which may include the legal framework for the specific purpose, which may pool funds or may hold assets of user investors in the SPV module 112.

The SPV module 112 may determine a set of parameters and structures that define how the SPV operates within the SaaS network 102. The parameters in the SPV module 112 may include the legal name of the SPV and its specific legal structure, a statement of the SPV's purpose and investment strategy within the SaaS network 102, a list of user investors contributing capital to the SPV and the specific amounts contributed by each user investor, management and governance of the SPV, which may include a board of directors, managing members, or investment managers, the governance structure, including decision-making processes, voting rights, and any specific roles or responsibilities. The SPV module 112 may include criteria such as target industries, geographies, asset classes, risk profiles, distribution of profits and losses, and associated fees if applicable. The SPV modules 112 may provide for amending the SPV's parameters and for terminating the SPV when its objectives have been met or when necessary. The SPV structure may help protect the user investor from specific project risks.

For example, John Smith wishes to invest $100K, with a target ROI of 10% over 10 years with a medium to high risk tolerance. Mr. Smith is interested in investing in Acme Solar, Inc. The SPV is the separate legal entity that may be created by the SPV module 112 for Acme Solar, Inc. to hold assets of the investment. The SPV module 112 may be prompted at step 608 to retrieve necessary forms for the SPV in the SaaS network 102. The SPV module 112 may retrieve necessary forms and documents that may include the certificate of incorporation and formation that may create the SPV as a legal entity, bylaws or operating agreement that may govern the SPV operation, subscription agreements that may outline the terms and conditions under which user investors fund the SPV, consent forms that may be required for approval of specific actions, tax election forms, banking and financial account forms, registration forms for regulatory authorities if applicable, policies and procedures that may relate to the SPV operations, compliance, and risk management of the SPV module 112.

The SPV module 112 may be prompted at step 610 to construct the SPV in the SaaS network 102. The SPV module 112 may include final SPV objectives and legal structure, final governing documents, identification of contributing user investors and amounts and terms of their contributions, establish risk tolerance, target industries, geographies, and asset classes if applicable, establish banking accounts, appoint individuals or entities to manage SPV operations, finalize investment agreements, implement risk management strategies, define reporting requirements for the SPV, comply with regulatory requirements, define a clear exit strategy for the SPV investment, including plans for realizing returns and distributing proceeds to user investors. Step 612 may be initiated after the SPV is constructed and may be returned to the Manage module 104.

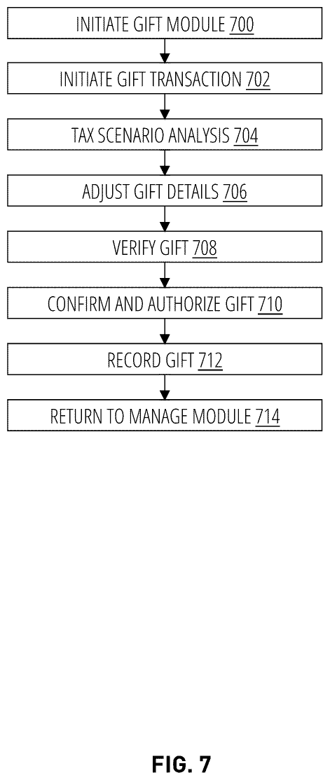

FIG. 7 illustrates an example method performed by a gift module.

The process begins with initiation at step 700 by the manage module 104. The gift module 123 may be prompted at step 702 to enable the user investor to select the option to initiate a new gift transaction. The user may be prompted to enter details of the gift, such as the type of asset being gifted, e.g., shares, bonds, cash, the quantity or value of the asset, and any specific conditions attached to the gift. The user investor may select the recipient of the gift or trust, which may involve entering the recipient's details manually or choosing from a list of potential recipients that may already be registered in the SaaS network 102.

For example, Sarah, a real estate investor, utilizes the gift module 123 to create a trust specifically for investing in real estate deals, with an additional gifting option to support her grandchildren's education. She establishes the “Real Estate Investment Trust” and allocates a portion of her assets to it, focusing primarily on income-generating properties. An investment opportunity in a commercial property arises within the deal module 110, and Sarah, as the trustee, opts to participate in this deal. She indicates the trust's interest in the investment, and the gift module 123 facilitates the integration of the trust's assets into the deal, funding the property acquisition.

The SPV database 124 may be automatically updated with this new information. Sarah may then activate the trust's gifting option to contribute to her grandchildren's education. She specifies the gift amount and the recipients within the trust's terms. A gifting transaction is initiated in the gift module 123 to transfer income from the trust to the educational fund. The SPV module 112 may conduct KYC verification for the grandchildren to ensure compliance with regulatory standards. Upon successful verification, the gifting transaction may be executed, with the specified amount transferred to the educational fund. The SPV database 124 maintains comprehensive records of both the real estate deal and the gifting transaction, ensuring transparency and auditability. This example demonstrates the integrated functionality of the gift module 123, SPV module 112, and SPV database 124 in managing real estate investments and facilitating educational support through gifting within the SaaS networks 102.

In another example, the gift module 123 may be utilized to facilitate a direct gift transaction. For instance, consider a user investor, John, who wishes to make a direct gift of shares to a charitable organization. John initiates the gift module 123 and may input the details of his gift, including the type and quantity of shares and the recipient organization's information. The gift module 123 may process this information, verifying the transaction's compliance with SaaS network 102 policies and regulatory standards. Simultaneously, the SPV database 124 may record the specifics of the share transfer. The SPV, a structured entity created for this specific transaction, facilitates the transfer of shares from John to the charitable organization. The SPV module 112 may oversee the legal and financial aspects of this transfer, ensuring that the process adheres to the necessary legal frameworks and investment guidelines.

The SPV database 124 may record all pertinent details, including the nature of the gift, the identities of the donor and recipient, the number of shares transferred, and the date of the transaction. The SPV database 124 serves as a comprehensive record, maintaining the integrity and transparency of the transaction. It also provides essential data for reporting, compliance, and auditing purposes within the network. This example illustrates the integrated functionality of the gift module 123 and the SPV database 124 in managing direct gift transactions. John's ability to gift shares to a charitable organization through the SaaS network 102 demonstrates assurance that the gift is processed efficiently, securely, and in compliance with all relevant regulations, thereby enhancing the user experience within the SaaS network 102.

Step 704 of the gift module 123 is designed for conducting a comprehensive tax scenario analysis for user investors, particularly emphasizing the unique structure of co-investments in the SaaS network 102. This step includes the anticipation of potential tax liabilities and the suggestion of optimal structuring for the gift to minimize tax impact, taking into account the specificities of the SaaS network 102. In situations where a user investor in the SaaS network 102 decides to gift their investment to a family member, the tax scenario analysis is undertaken. Typically, in many jurisdictions, gifts exceeding a certain threshold are subject to gift tax, which is usually the donor's responsibility. The analysis is performed to account for the current value of the gifted asset and to compare it with the annual or lifetime gift tax exclusion limits, determining if a gift tax liability might be incurred. State-level taxes are also considered when applicable.

In the case of an investor like Rachel, looking to establish a charitable lead trust with her tech start-up investments in the SaaS network 102, the tax implications of this arrangement are evaluated by the gift module 123. The analysis may include the calculation of potential tax deductions for the present value of the income stream designated to the charity while maintaining the remainder interest in the investments. Factors such as her current tax rate and the specific nature of her investments in the network are taken into account. The gift module 123 has been enhanced to include an options selection step, which further refines the gift tax scenario analysis. This step enables the calculation of various choices, each with different tax implications. The application of the annual gift tax exclusion is assessed to determine the amount that can be gifted to each recipient every year without incurring gift taxes. The impact of making direct payments for education to educational institutions, not subject to gift tax, is calculated. Benefits of making direct payments to medical institutions for someone else's care, also excluded from gift tax, are evaluated.

Additionally, the suitability of contributions to a 529 college savings plan under the annual gift tax exclusion is considered, including the potential for front-loading multiple years' contributions in one sum. The option of transferring stock to UGMA or UTMA accounts is assessed, utilizing the annual exclusion while facilitating gifts to minors. The possibility of gift splitting for married couples is explored, which can effectively double the annual exclusion amount they can give to an individual without incurring taxes.

The gift adjustment process at step 706 allows for structure modifications to a gift based on tax implications and optimal tax efficiency. For example, Julia, a user investor, decides to transfer a portion of her investment in a green technology project directly to a charitable organization focused on environmental sustainability. The tax scenario analysis reveals several tax considerations for Julia. Firstly, she benefits from a charitable tax deduction, allowing her to deduct the fair market value of the donated investment, say $50,000, from her taxable income.

This deduction may significantly reduce her overall taxable income for the year as she donates the asset directly rather than selling it first. The tax scenario analysis may also consider the IRS limits on charitable deductions, which may be capped at a certain percentage of her adjusted gross income (AGI). If her gift exceeds this limit, she can carry forward the excess deduction, providing tax benefits beyond the current year. Since the recipient is a public charity, Julia may also take advantage of more favorable deduction limits compared to private foundations. Additionally, the tax scenario may alert Julia to how her large donation may impact her alternative minimum tax (AMT) liability and the tax efficiency of the gift.

In this scenario, the gift module 123 assists Julia in navigating the various tax implications of her gift, assisting in calculating the charitable tax deduction, understanding the impact on her AMT liability, and exploring structured giving options, ensuring that her philanthropic objectives are achieved. At step 708, the user investor reviews and verifies all entered information, including any adjustments made in step 706. This step may include a review of the tax implications presented in the tax analysis, ensuring the gift aligns with the user's tax strategy. The user investor may review and verify all entered information, including the recipient's details, asset type and quantity, transaction terms, and the tax implications assessed in step 704.

For example, a user investor named Sarah who wishes to gift a portion of her investment portfolio to her nephew, Alex, as part of his college fund. Sarah initiates the gifting process through the network's gift module 123, which initiates several verification steps to ensure the accuracy and compliance of the transaction. Sarah first reviews the recipient's details, including Alex's full name, date of birth, and social security number, which the system cross-references with public records to confirm his identity, ensuring the gift is received by the intended recipient and complies with legal and tax requirements. Sarah then verifies the asset she intends to gift. The gift module 123 displays the current market value of the investment, allowing Sarah to confirm that the gift aligns with her financial goals and intentions. Sarah may then review the transaction terms, date of the gift, and transfer to Alex's custodial account, confirming any conditions attached to the gift, such as the intended use for educational expenses.

Finally, Sarah completes the security, compliance, and policy checks implemented by the SaaS network 102 that the size of her gift is within the SaaS network 102 limits and confirms that the asset she intends to gift is free from any other obligations. After verifying the gift details, which may include the tax scenario analysis, the user investor may confirm and authorize the gift transaction at step 710. This step may involve additional considerations based on the tax analysis, such as confirming the willingness to proceed despite potential tax liabilities or taking advantage of possible tax benefits. For example, the user investor is presented with a comprehensive summary of the transaction, which may include the recipient's verified details, the specific assets being gifted, the current market value of these assets, the intended date of transfer, and conditions attached to the gift. The user investor may be required to acknowledge understanding the legal and tax implications of the gift and compliance with the rules and limits set by the SaaS network 102. The user investor may undergo a robust authentication process, entering a secure password and then completing a two-factor authentication step, which might include a biometric check or a code sent to her verified mobile device.

After authentication, the user investor may be presented with a final confirmation prompt and authorization of the gift. At step 712, the details of the gift transaction may be automatically recorded in the network's SPV database 124 and relevant databases such as the member database 120 and deal database 122. The recipient of the gift may be notified, if applicable, informing them of the received gift and any necessary actions they may need to take. For example, consider a scenario where a non-profit organization receives a gift of securities. Upon notification of the gift, the organization may need to take specific actions, such as acknowledging receipt of the gift for tax purposes, which is often a requirement for both the donor's and the recipient's tax records.

Additionally, the organization might need to decide whether to hold or liquidate the received securities, a decision that could depend on its investment policy or immediate financial needs. If the decision is to liquidate, the organization may initiate the process of selling the securities, which involves coordinating with their financial institution or broker. Furthermore, the organization may be required to update its financial records and report the gift in its financial statements, ensuring compliance with accounting standards and transparency in its financial reporting. These actions, necessitated by the receipt of a gift, facilitate the transfer of gifts but also ensure that recipients are aware of and can efficiently manage the responsibilities and implications associated with receiving such gifts within the SaaS network 102. Step 714 may be initiated after the user investor completes the gift module 123 information and may be returned to the manage module 104.

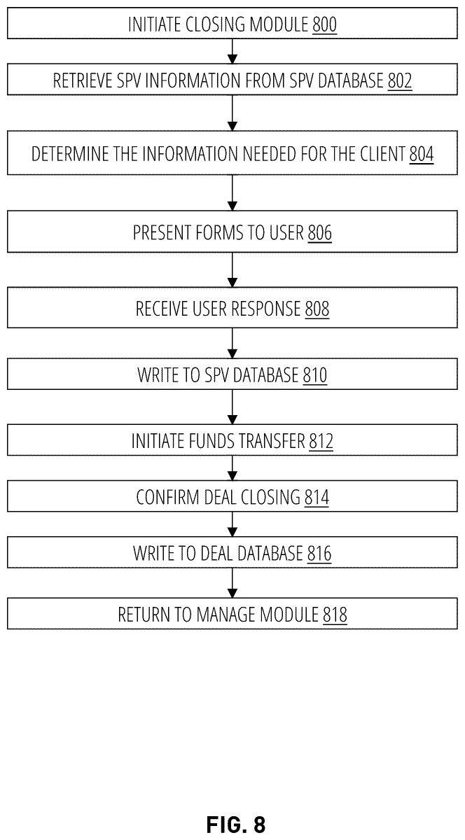

FIG. 8 illustrates an example method performed by a closing module.

The closing module 114 may be initiated at step 800 by the manage module. The closing module 114 may be prompted at step 802 to retrieve SPV information from the SPV database 124. The blockchain module 119 may integrate with the report module 116 to enhance the accuracy, transparency, and efficiency of data updates and reporting within the SaaS network 102 at step 902. The blockchain module 119 may assist in managing the deal database 122 and report module 116 to ensure that all parties involved have access to up-to-date information and associated reports. The blockchain module 119 may actively monitor the deal database 122 for any data updates or changes relevant to ongoing deals. These updates may include changes in deal terms, financial performance metrics, or milestones achieved.

When such updates occur, the blockchain module may capture and record these changes in real time on the blockchain network 134, creating an immutable and transparent audit trail of all modifications. The blockchain module 119 may serve as a trusted source for data verification and validation. Authorized parties involved in a deal, including investors, stakeholders, and regulators, may access the blockchain to independently verify the accuracy and authenticity of the recorded data, which may include deal progress, financial performance, compliance issues, or any other relevant metrics and may reduce or eliminate the need for time-consuming and error-prone reconciliation processes. Once reports are generated, they may be securely distributed to authorized parties within the SaaS network 102. The blockchain module 119 may facilitate report distribution, ensuring that only authorized individuals or entities receive the reports. This may enhance transparency and trust among stakeholders, as they can independently verify the information presented in the reports against the blockchain's immutable record. This interaction between the blockchain module 119 and the report module 116 may streamline data updates, verification, and report distribution, providing an efficient and trustworthy mechanism for managing deal information and facilitating informed decision-making among all relevant parties.

For example, Sarah is an individual user investor who uses the SaaS network 102 to manage her diverse investment deals, which include investments in startups, real estate, and securities. The blockchain module 119 may play a vital role in ensuring the accuracy and transparency of her investments, while the report module 116 assists in generating informative reports. Sarah actively manages her investment deals through the deal module 110 within the SaaS network 102. Her portfolio may consist of equity stakes in several startups, ownership of real estate properties, and a diversified portfolio of investments, all governed by smart contracts recorded on the blockchain.

The blockchain module 119 continually monitors the deal database 122 for real-time data updates related to each of Sarah's investments. These updates include changes in the startups' performance metrics, rental income from real estate properties, and fluctuations in the value of her deals. When data updates occur, the blockchain module 119 may capture and record these changes on the blockchain network 134 in real time. This creates an immutable and transparent audit trail of all modifications, ensuring the accuracy and authenticity of Sarah's investment data. Sarah may use the report module 116 to generate personalized investment reports summarizing the financial performance and progress of her entire investment portfolio. These reports may rely on data sourced directly from the blockchain's immutable ledger.

The blockchain module 119 may ensure the secure distribution of these reports to Sarah's authorized devices. Only she can access and review these comprehensive reports, safeguarding her investment data. Sarah may independently verify the information presented in the reports against the blockchain's immutable record, reinforcing her trust in the accuracy of the data. The blockchain serves as a trusted source for data validation. Equipped with verified and up-to-date information, Sarah may make well-informed investment decisions, adjust her investment strategy, allocate resources, and diversify her portfolio as needed, all with confidence in the reliability of her investment data, illustrating how the blockchain module 119 and the report module 116 collaboratively provide an individual user investor like Sarah with real-time investment data updates, personalized report generation, and independent data verification. The report module 116 may be prompted at step 904 to retrieve deal information from the deal database 122.

The SPV database 124 may contain the unique identifier of the SPV and may provide the fund name that created the SPV, company name or target of investment, investment amount, SPV status, and summary of the SPV investment. The information needed from the client may be prompted by the closing module 114 at step 804. The information from the client may include the investor's name, email address, phone number, and mailing address, the type of investment vehicle that the investor will be using to make the investment, such as a personal investment, the total amount of investment in the deal, investment terms, investor experience and associated information from the KYC module 108. For example, for user investors who may be investing in early-stage startups, the closing module 114 may coordinate the documentation process between the startup and the user investor. The closing module 114 may automatically generate and track investment agreements, ensuring that all parties adhere to the predefined terms. Additionally, the closing module 114 may coordinate the transfer of funds and the issuance of equity shares or convertible notes, managing compliance with regulatory requirements.

The closing module 114 may automatically draft convertible note agreements and facilitate the electronic signing of documents, streamlining the investment closure process for tech-savvy user investors interested in early-stage ventures. Conversely, the closing module 114 may cater to a different type of user investor interested in real estate investments. These user investors may often engage in transactions involving commercial properties, residential complexes, or development projects. The closing module 114 may support a seamless real estate transaction closure by managing critical aspects such as escrow services, title searches, and legal documentation. The closing module 114 may facilitate the exchange of funds, verify property titles, and coordinate with relevant stakeholders, including real estate agents and legal representatives. Moreover, the closing module 114 may assist in compliance with local regulations and tax obligations related to the real estate transaction.

This example showcases the adaptability of the closing module 114 to a distinct category of user investors seeking to diversify their portfolios with tangible assets by providing services that may relate to real estate investment closure. These two different examples emphasize the versatility of the closing module 114 within the SaaS network 102, adeptly managing the intricacies of investment closure for a wide range of user investors with unique investment preferences and asset classes, ultimately ensuring a smooth and secure transaction process. The closing module 114 may be prompted at step 806, which may present forms to the user investor in the SaaS network 102. Forms may be presented to the user investor in the closing module 114.

They may include authorization to release funds from the user investor to fund the deal. This subscription agreement may outline the terms of the investment, including the amount invested, the ownership stake acquired, and the rights and responsibilities of both parties, a securities purchase agreement that may govern the purchase of securities by the user investor and other forms that may include a non-disclosure agreement or intellectual property license agreement. It may be determined at step 808 that the user investor has confirmed receipt and executed necessary forms in the closing module 114. The closing module 114 may be prompted at step 810 to write the deal to the SPV database 124. The process may include connecting to the SPV database 124 using the credentials provided by the SPV administrator, creating a new deal record in the SPV database 124, populating the deal record that may include the deal name, deal type, deal amount, deal date, deal status, deal parties, deal terms and committing the deal record to the SPV database 124.

Once the deal has been written to the SPV database 124, it can be accessed by the SPV administrator and other authorized users. The closing module 114 may be prompted at step 812 to initiate funds transfer to the SPV module 112. The closing module 114 may initiate the transfer of user investor funds to the SPV module 112 and may include receiving a request to invest in the SPV from the web, client application 132, or cloud 126. The closing module 114 may validate the request to transfer funds. The closing module 114 may initiate funds transfer through a bank transfer, wire transfer, or a payment processor.

Once the funds transfer to the SPV is complete, the closing module 114 may update the user investor account balance and the SPV account balance to reflect the transaction in the SPV module 112. For example, Mr. Smith may invest $100,000 in Acme Solar, Inc. through an SPV in the SPV module 112. The closing module 114 generates a payment request to Mr. Smith for the SPV module 112 for $100,000. The payment request to Mr. Smith includes the date the funds will be transferred and his bank account information for the SPV module 112. The closing module 114 may initiate the payment request to the SPV module 112. The SPV module 112 may review the payment request and verify Mr. Smith's information is correct. The SPV module 112 may initiate a wire transfer of $100,000 from Mr. Smith's bank. The closing module 114 may be prompted at step 814 to confirm the deal closing in the SaaS network 102. The deal closing process may include reviewing all documents, signing the closing documents, signifying the deal is finalized, and all parties are bound to the terms and conditions.

For example, when Mr. Smith has reviewed and signed the closing documents in the closing module 114 relating to Acme Solor, Inc., the investment may be closed, and Mr. Smith may become a shareholder of the SPV. Upon confirmation of the deal closing, the closing module 114 may be prompted at step 816 to write the closed deal to the deal database 122. The process may include querying the SPV database 124, that may identify the deal data. The deal database 122 may record the deal that may include the unique deal identification, user investor, company name, industry sector, and investment amount. Upon completion of writing to the deal database 122, step 818 may be initiated and return to the manage module 104.

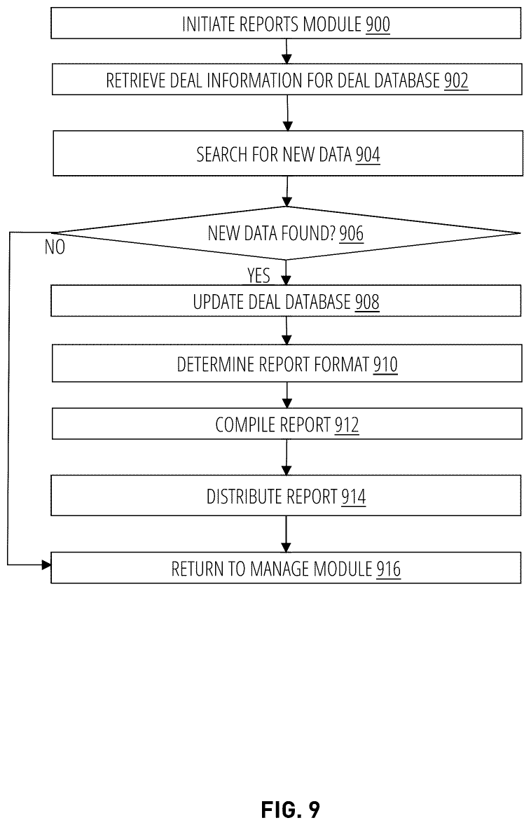

FIG. 9 illustrates an example method performed by a reports module.

The reports module 116 may be initiated at step 900 by the Manage module 104. The reports module 116 may be prompted at step 902 to retrieve deal information from the deal database 122.

The blockchain module 119 may integrate with the report module 116 to enhance the accuracy, transparency, and efficiency of data updates and reporting within the SaaS network 102. The blockchain module 119 may assist in managing the deal database 122 and report module 116 to ensure that all parties involved have access to up-to-date information and associated reports. The blockchain module 119 may actively monitor the deal database 122 for any data updates or changes relevant to ongoing deals. These updates may include changes in deal terms, financial performance metrics, or milestones achieved.

When such updates occur, the blockchain module may capture and record these changes in real time on the blockchain network 134, creating an immutable and transparent audit trail of all modifications. The blockchain module 119 may serve as a trusted source for data verification and validation. Authorized parties involved in a deal, including investors, stakeholders, and regulators, may access the blockchain to independently verify the accuracy and authenticity of the recorded data, which may include deal progress, financial performance, compliance issues, or any other relevant metrics and may reduce or eliminate the need for time-consuming and error-prone reconciliation processes. Once reports are generated, they may be securely distributed to authorized parties within the SaaS network 102.

The blockchain module 119 may facilitate report distribution, ensuring that only authorized individuals or entities receive the reports. This may enhance transparency and trust among stakeholders, as they can independently verify the information presented in the reports against the blockchain's immutable record. This interaction between the blockchain module 119 and the report module 116 may streamline data updates, verification, and report distribution, providing an efficient and trustworthy mechanism for managing deal information and facilitating informed decision-making among all relevant parties. For example, Sarah is an individual user investor who uses the SaaS network 102 to manage her diverse investment deals, which include investments in startups, real estate, and securities.

The blockchain module 119 may play a vital role in ensuring the accuracy and transparency of her investments, while the report module 116 assists in generating informative reports. Sarah actively manages her investment deals through the deal module 110 within the SaaS network 102. Her portfolio may consist of equity stakes in several startups, ownership of real estate properties, and a diversified portfolio of investments, all governed by smart contracts recorded on the blockchain. The blockchain module 119 continually monitors the deal database 122 for real-time data updates related to each of Sarah's investments.

These updates include changes in the startups' performance metrics, rental income from real estate properties, and fluctuations in the value of her deals. When data updates occur, the blockchain module 119 may capture and record these changes on the blockchain network 134 in real time. This creates an immutable and transparent audit trail of all modifications, ensuring the accuracy and authenticity of Sarah's investment data. Sarah may use the report module 116 to generate personalized investment reports summarizing the financial performance and progress of her entire investment portfolio. These reports may rely on data sourced directly from the blockchain's immutable ledger.

The blockchain module 119 may ensure the secure distribution of these reports to Sarah's authorized devices. Only she can access and review these comprehensive reports, safeguarding her investment data. Sarah may independently verify the information presented in the reports against the blockchain's immutable record, reinforcing her trust in the accuracy of the data. The blockchain serves as a trusted source for data validation. Equipped with verified and up-to-date information, Sarah may make well-informed investment decisions, adjust her investment strategy, allocate resources, and diversify her portfolio as needed, all with confidence in the reliability of her investment data, illustrating how the blockchain module 119 and the report module 116 collaboratively provide an individual user investor like Sarah with real-time investment data updates, personalized report generation, and independent data verification. The report module 116 may be prompted to retrieve deal information from the deal database 122.

Upon authentication and authorization from the user investor, the deal database 122 may query, filter, aggregate, and return information to the reports module 116, such as the unique deal ID, company name, industry sector, and status of investment, either open, closed, or withdrawn. The deal database 122 may be prompted at step 904 to search for new data.

The reports module 116 may retrieve and prioritize all deals created or updated since the last time the reports module 116 was generated. The reports module 116 may extract and prioritize new information that may include deal progress, stage of investment, deal value, deals due to close in a certain time frame, deal terms, and new user investors. The reports module 116 may retrieve deal data in real time or over a period of time. Examples of new data elements retrieved by the reports module 116 may include updated financial reports, government filings, press announcements, industry trends, changes in deal size, and key management individuals.

It may be determined at step 902 that the reports module 116 may have retrieved new data from the deal database 122. If new data from the deal database 122 has been identified and retrieved, the process may proceed to step 908, and the deal database 122 may be updated with new data. If no new data is found at step 904, step 916 may be initiated and may return to Manage module 104. The deal database 122 may be updated with new information at decision block 906. Determining the report format in the reports module 116 may be initiated at step 910. Once the reports module 116 has extracted the relevant data from the deal database 122, the data may be organized into multiple report formats that may include table format that displays data in rows, columns, headers, footers, and other format elements, chart formats to visualize data that may include bar charts, line charts, pie charts, and scatter plots, narrative text format or image formats.

The reports module 116 may compile a report at step 912 on the deal(s) the user investor selected from the deal database 122. The reports module 116 may use a query process of extracting data from the deal database 122, which may be based on specific criteria or updated data from the deal database 122. The reports module 116 may compile reports based on all deals in the deal database 122, deals in a specific stage, for example, open, closed, or withdrawn, deals by value, profitability, risk, trends, or patterns. A user investor may use compiled reports from the reports module 116 to make informed decisions about a possible investment. For example, user investors may rely on the reports module 116 to generate comprehensive reports that provide insights into the performance of their investments. The reports module 116 may compile data on key performance indicators (KPIs) such as revenue growth and market share, presenting these metrics in visually informative dashboards and reports.

For instance, the reports module 116 may incorporate data on a startup's technology roadmap and milestones achieved. These reports may enable user investors to make informed decisions regarding their investment portfolio, identifying which startup investment(s) are meeting their objectives and which may require adjustments. This example demonstrates how the reports module 116 may cater to tech-savvy investors seeking data-driven insights into their investment activities in the technology sector. Conversely, the reports module 116 may serve a different type of user investor focused on real estate investments. These investors use the module to assess the performance of their diversified real estate portfolio. The reports module 116 may compile data on rental income, property appreciation, occupancy rates, and property management expenses, presenting this information in clear, customized reports. It also may report metrics like net operating income (NOI) and return on investment (ROI) for each property in the portfolio.

Additionally, the reports module 116 may offer insights into regional real estate market trends and forecasts. By providing these comprehensive reports, the reports module 116 may empower user investors to optimize their real estate investments, make strategic decisions regarding property acquisitions or divestitures, and ensure their real estate portfolio aligns with their financial objectives. These two different examples highlight the adaptability of the reports module 116 within the SaaS network 102, enabling user investors with diverse investment preferences to access tailored, data-driven reports that enhance their decision-making capabilities and contribute to the success of their investment activities. The reports module 116 may be initiated at step 914 to distribute the report to user investors. After the report module distributes completed reports, step 916 may be initiated and returned to the Manage module 104.

Additionally, the reports module 116 may utilize the output from the AI analytics module 121 to customize the presentation of a report for a specific user investor based on their profile characteristics. For instance, if the AI determines that the user has a history of extensive engagement with visual data, the report might be adjusted to include more charts and graphic al representations. This determination could be based on the user's previous interactions with the SaaS network 102, where it was noted that the user investor spent more time on pages with visual elements than on text-heavy sections.

The AI analytics module 121 may have identified a cohort of user investors with similar behaviors, such as professionals in their early forties, with a preference for technology and healthcare investments, who often review reports on mobile devices during the early morning hours. For these user investors, reports with dense paragraphs of text led to a decrease in engagement, whereas reports featuring visual data points saw higher interaction rates. Based on this insight, the reports module 116 might augment the forthcoming report for this cohort by prioritizing visual elements. It could increase the use of infographics that succinctly convey the performance metrics of interest, like growth trajectories or market comparisons, and decrease the volume of narrative text.

This adjustment is made in anticipation that the tailored report will enhance the user's engagement and comprehension, leading to a more informed investment decision. The change in report presentation is an example of how the report module responds dynamically to user behaviors and preferences, leveraging AI to deliver a more personalized and effective user experience. The reports module 116 may be initiated at to distribute report to user investors. After the report module distributes completed reports may be initiated and is returned to the manage module 104.

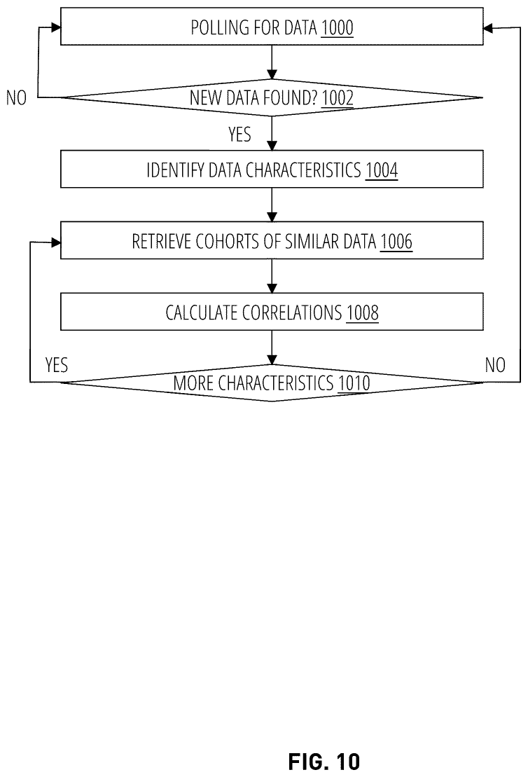

FIG. 10 illustrates an example method performed by an AI analytics module.

The AI analytics module 121 may be continuously polling one or all of the member database 120, the deal database 122, and the SPV database 126 for new data, or changes to existing data. It may be determined at step 1002 if new or changed data was found. For example, if a user investor is providing information used to construct or alter their KYC profile to the KYC module 108, that new data would appear in the member database 120. If no new or changed data is found at step 1002, the process returns to step 1000 and continues polling for data. If new or changed data was found at step 1002, the characteristics of that data may be identified at step 1004.

For example, if a user investor has invests in a deal there are many characteristics of the user and the deal that could be considered. Characteristics could include demographic data about the user investor, such as their age, gender, location, etc. Characteristics could also include aspects of their KYC profile, such as an affinity for biotech investment or an aversion to deals in which their equity share is less than 1%. Characteristics of the deal could include the technology sector, age of the company, size of the investment, etc. The context in which the user encounters the deal could also be characteristics that are considered.

For example, the number of other investors already committed, the available equity, how many deals the user has already invested in through the SaaS network 102, how the deal is presented, if the user invested in the previous deal they were shown, etc. Once characteristics of the new or changed data are identified, cohorts of similar data may be retrieved at step 1006 from the relevant database(s). For example, if the new data received is a user investor John electing not to invest in a deal presented to them, there are a number of cohorts that could be constructed. Each cohort will contain the characteristic of a user investor electing not to invest in a deal and at least one other characteristic. It could be a characteristic of the deal, such as the technology sector. In that example, the AI analytics module 121 would retrieve data related to all the times a user investor declined to invest in deals in the same technology sector.

This would necessitate retrieving deal data from the deal database 122 as well as user investor data from the member database 120. Cohorts could be defined using many characteristics. For example, a cohort could all the times user investors between 40 and 50 years old, who live in NYC, declined to invest in a financial services company that was on its third round of funding. Each new data point could be used to create many different cohorts of other data point that share at least two characteristics with the current data point. Cross correlation may be performed at step 1008. This process allows the AI analytics module 121 to determine if there is a strong enough correlation between characteristics of deals, user investors, and the context in which deals are presented to user investors, and different investing outcomes.

Upon identifying that John, a user investor, has opted out of an investment, the AI analytics module may define a cohort of investors who are professionals in the medical field, aged 35-45, who have previously declined deals in the biotech sector when the equity offered was below 5%. Cross-correlation could then analyze the relationship between the amount these investors have historically invested in biotech deals and the equity percentage offered. The analysis might reveal a correlation coefficient of 0.85, indicating a strong positive correlation and surpassing the significance threshold of 0.75 set by the platform to identify relevant correlations. In contrast, the AI could examine the correlation between the amount invested and the time elapsed since the last investment made by this cohort. The resulting correlation coefficient might be 0.05, indicating a very weak positive relationship between these variables.

This coefficient is significantly below the threshold of relevance, suggesting that the time elapsed since the last investment is not a predictor of the amount invested in subsequent deals for this cohort. This helps the platform in disregarding such characteristics when analyzing investment behaviors. In another embodiment, a machine learning model could be trained to predict investment behaviors based on historical data. First, one would gather a dataset comprising various investor characteristics (e.g., demographic information, past investment history, risk tolerance, etc.), deal attributes (e.g., sector, stage of the company, equity offered, etc.), and context of the deal presentation (e.g., time since the last investment, whether the previous deal was accepted or declined, etc.). This dataset is then preprocessed to handle categorical variables through one-hot encoding, normalize numerical values, and handle missing values through imputation. Once the data is prepared, it is split into a training set and a test set.

A supervised learning algorithm, such as a Random Forest or Gradient Boosting Machine, could then trained on the training set to learn the patterns associated with investment amounts. The model could use the features from the investor and deal characteristics to predict the target variable, which is the amount invested. Over time, as the model is exposed to more data, it becomes better at predicting how much a given investor would invest in a particular deal. The model's performance is evaluated using the test set and metrics such as Mean Absolute Error (MAE) or Root Mean Squared Error (RMSE) to ensure it accurately predicts investment amounts. In another embodiment, one might employ a neural network, specifically a deep feedforward network, to handle the same prediction task.

Neural networks excel at identifying nonlinear relationships within high-dimensional data, which can be particularly useful when dealing with varied and complex investor and deal characteristics. In this approach, after data preprocessing, the dataset feeds into a neural network consisting of an input layer, several hidden layers, and an output layer. The input layer receives the encoded features, the hidden layers process the features through weighted connections and activation functions, and the output layer produces the prediction of the investment amount. To optimize the network, you would use backpropagation with an optimization algorithm like Adam or SGD to minimize a loss function, such as mean squared error, over several iterations of training. As the network trains, you would also implement techniques such as dropout for regularization to prevent overfitting to the training data. After training, you evaluate the neural network's performance using the test set. If the predictions align closely with the actual investment amounts, the network can be deployed to aid in real-time investment predictions, dynamically updating as new data comes in.

The AI analytics module 121 may also use more than one type of AI in concert with one another, or apply different types of AI in different situations. For example, a machine learning algorithm such as Random Forest may be used to sift through historical investment data. This model might identify key features that predict investment decisions, like demographics, investment history, or deal specifics. The identification of these features could help in simplifying the dataset and might also offer insights into what drives investment behaviors. These key features might then be fed into a neural network, which could be capable of uncovering complex relationships in the data. The neural network, with its capacity for modeling non-linear interactions, may find patterns that are not immediately apparent to simpler algorithms. This step could lead to predictions that are both accurate and nuanced, reflecting the intricate nature of investment decisions. The outputs from the machine learning model and the neural network may then be combined.

This could be through a process like model stacking, where the predictions from individual models serve as inputs for another model that provides a final prediction. This combined approach may yield better results than any single model on its own. Alternatively, the machine learning model may segment investors into categories, and separate neural network models may be trained for each segment, potentially allowing for predictions that are tailored to specific investor profiles. As the platform evolves and more data becomes available, both the machine learning algorithm and the neural network may be updated to refine their predictions. This might involve retraining with new data or implementing online learning methods to adjust the models continuously. Such updates may ensure that the platform remains responsive to the latest market trends and investor behavior patterns. The use of machine learning and neural networks in this manner may provide a way to offer precise investment opportunities, enhancing the system's utility over time. It may be determined at decision block 1010 if there are more characteristics to examine. If yes, the AI analytics module 121 returns to step 1004. If there are no more characteristics to examine, the AI analytics module 121 returns to step 1000.

FIG. 11 illustrates an example method performed by a blockchain module.

The process begins with step 1100. The blockchain module 119 polls for new data from the SaaS network 102, continually monitoring for any incoming information. This continuous monitoring involves an automated system that may constantly scan for any incoming information or updates originating from the SaaS network 102. These updates may encompass a wide range of data, such as changes in accredited investor status from the AIA module 106, updated personal information, or new investment preferences from the KYC module 108 or other relevant module data. The polling process may operate seamlessly in the background, ensuring that the blockchain module 119 remains active and responsive to any new data, thereby maintaining the SaaS network 102 real-time accuracy. By actively seeking and capturing new data, the blockchain module 119 may serve as a crucial gateway for integrating new content into the secure and immutable blockchain infrastructure, bolstering the network's capabilities for data-driven decision-making and enhanced user experiences. For example, an investor named Sarah did not initially receive accredited investor status in the AIA module 106 since she did not meet the financial criteria required for accreditation. Over time, Sarah's financial situation has improved significantly, and she now meets the accreditation criteria, including having an annual income of over $200,000 for the past two years. The blockchain module 119, actively polling for new data, detects this change in Sarah's accredited investor status within the AIA module 106. It automatically initiates the process of updating her status on the blockchain network 134, ensuring that her profile accurately reflects her newfound accreditation. This real-time update not only enhances the integrity of the blockchain but also enables Sarah to access a broader range of investment opportunities.

Another example may include user investor Alex, who has recently moved to a new city and updated his address and investment criteria in the KYC module 108 to reflect this change. The blockchain module 119, continually monitoring for incoming information, identifies this modification in Alex's personal data and may automatically initiate the process of verifying and recording this change on the blockchain network 134, ensuring that Alex's up-to-date information is securely stored in an immutable manner on the blockchain, providing an accurate and auditable record of his details. This proactive monitoring and recording of changes enhance the transparency and reliability of data on the SaaS network 102, enabling user investors to trust the platform for their investment needs. In these examples, the blockchain module 119 actively and automatically seeks out new data, whether it's a change in accreditation status or updated personal information.

This continual polling and integration of new content into the blockchain infrastructure contribute to a dynamic and reliable SaaS network 102, fostering user trust and supporting data-driven decision-making. Upon polling for new data at decision block 1102, the blockchain module 119 module may scrutinize the incoming data stream to determine whether any new information has materialized within the SaaS network 102. This determination process may involve a comparison between the incoming data and the existing dataset, with the blockchain module 119 tracking timestamps and versioning for precise identification of any changes. If, during this analysis process, the blockchain module 119 identifies the presence of new data, the process may seamlessly progress to step 1104, priming the module to interact with the blockchain network 134.

Conversely, suppose the analysis reveals no new data, indicating that the SaaS network 102 remains unaltered. In that case, the process may seamlessly circle back to step 1100 in a continuous loop, initiating another polling cycle to ensure that even the smallest updates are captured and integrated into the blockchain network 134. This iterative polling mechanism may ensure real-time data synchronization and maintain the SaaS network 102 status as an up-to-the-minute source of accurate and responsive information for user investors and relevant stakeholders. When new data is confirmed within the SaaS network 102, the blockchain module 119 may query the blockchain network 134 at step 1104 to assess whether a new blockchain needs to be created or if the data can be saved on the existing blockchain.

This process may involve assessing the nature and scale of the new data to make a crucial determination. Specifically, the blockchain module 119 may scrutinize whether the incoming data warrants the creation of a new blockchain, necessitating the establishment of a distinct ledger structure to accommodate this unique dataset, or if the data can be seamlessly incorporated into the existing blockchain infrastructure. This process may be informed but not limited to several factors, including data volume, security requirements, and compatibility with the existing blockchain structure. If the incoming data presents characteristics that warrant the creation of a new blockchain, the module may initiate this process, establishing a dedicated blockchain network segment to accommodate the data's unique attributes.

Alternatively, if the new data harmonizes with the existing blockchain's architecture and objectives, the blockchain module 119 may save it onto the existing blockchain, ensuring seamless integration and data continuity. The blockchain module 119 decision-making framework optimizes data management and storage while maintaining the network's overall efficiency and coherence. It ensures that the network's scalability and adaptability align with the evolving data landscape, enabling it to remain a robust and reliable foundation for the SaaS network 102. if a new blockchain is required for the data, the blockchain module 119 initiates the creation of a new blockchain specifically for this purpose at step 1106.

This process may begin with the precise configuration of the new blockchain, including defining its structural parameters, consensus mechanisms, cryptographic protocols, and tailored features to best suit the unique attributes of the incoming data. The blockchain module 119 may establish the foundational genesis block, housing critical information about the blockchain's inception. To ensure decentralization and robust security, it may establish a network of blockchain nodes instrumental in validating and preserving transaction and data integrity. Depending on the data's nature, it may be segmented within the new blockchain to optimize organization and accessibility. For example, a scenario where a user investor named David discovers a unique investment opportunity within the SaaS network 102, which may involve a novel financial instrument that hasn't been previously offered on the SaaS network 102. The blockchain module 119, upon confirming this new data related to the investment opportunity, may initiate the decision-making process, assessing the nature of the data, which, in this case, signifies the creation of a new financial instrument with distinct attributes and terms. The blockchain module 119 recognizes that this data warrants the creation of a new blockchain to accommodate the unique investment opportunity.

Consequently, it may proceed to establish a dedicated blockchain network segment specifically tailored to manage this novel financial instrument, ensuring that the investment data remains organized, secure, and efficiently accessible within its dedicated blockchain structure. This segmentation of data prevents any potential interference with the existing blockchain architecture and allows for precise tracking and management of this innovative investment opportunity. Stringent security measures, encompassing encryption and access controls, may be implemented to safeguard the data's confidentiality and integrity. Finally, the new blockchain is seamlessly registered within the blockchain network 134, facilitating fluid interactions with other blockchain segments and modules. Conversely, if the existing blockchain architecture aligns with the incoming data's requirements, the module efficiently proceeds to save the data onto the existing blockchain, preserving structural continuity and data integrity throughout the SaaS network 102.

For example, consider another scenario where a user investor, Sarah, updates her investment preferences within the SaaS network 102. She modifies her investment profile by specifying new preferences, such as higher risk tolerance and a focus on emerging technology sectors. The blockchain module 119, as it actively monitors incoming data, detects these updates within the KYC module 108. In this case, the blockchain module 119 evaluates the nature of the data changes and determines that Sarah's updated investment preferences align seamlessly with the existing blockchain infrastructure and objectives. The changes to her profile are within the scope of data that the current blockchain can accommodate without the need for significant alterations or dedicated segments.

As a result, the blockchain module 119 saves Sarah's updated investment preferences onto the existing blockchain, ensuring that her profile remains securely and transparently stored within the established blockchain structure. This decision may optimize data management, promote data continuity, and maintain the network's efficiency without the necessity of creating a new blockchain. In both examples, the blockchain module 119's decision-making process may be driven by factors such as the unique characteristics of incoming data, the scalability of the blockchain network, and its compatibility with the existing blockchain structure. This approach may ensure that the SaaS network 102 can effectively adapt to changing data landscapes while maintaining its overall efficiency and coherence.

If a new blockchain is required, the blockchain module 119 may initiate the creation of a new blockchain specifically for this purpose and save the new blockchain at step 1108. This process may include the creation of data blocks, each comprising a set of transactions or data entries formatted to meet the specifications of the blockchain protocol, and may undergo a rigorous validation process executed by nodes within the blockchain network 134. These nodes are responsible for verifying the authenticity and adherence of the transactions to the blockchain's governing rules.

This process may include a consensus mechanism establishing unanimous agreement among nodes on the validity of each data block, ensuring that only verified and consensus-approved data is appended to the blockchain. Subsequent to validation, each data block may be subjected to a hashing process, which may involve transforming the data into a fixed-size string of characters through a hash function, uniquely and securely representing the block. Each new block may incorporate the hash of its predecessor, thereby chronologically and securely linking the blocks in an unalterable chain. Following hashing, the block is ready to be added to the blockchain.

This stage involves disseminating the new block to all network nodes, thereby updating every copy of the blockchain across the blockchain network 134. This synchronization ensures uniformity and accuracy of the blockchain on all nodes. Once a block is integrated into the blockchain, it attains a state of immutability, rendering it unmodifiable and indelible. The blockchain continues to grow as more blocks are added, each undergoing the same stringent process of validation, hashing, and linking, emphasizing the trust and reliability inherent in this digital ledger technology. The blockchain module 119 may securely save the data onto the blockchain network 134 at step 1110.

This ensures the data's immutability, transparency, and resistance to tampering while also maintaining a comprehensive and secure record, implementing a series of advanced cryptographic operations and protocols. The data is first prepared for blockchain storage, undergoing encryption processes to ensure its confidentiality and resilience against unauthorized access. The blockchain module 119 may construct a transaction that encapsulates the data, complete with relevant metadata and references, designed to uphold the integrity and transparency of the transaction on the blockchain. The transaction may then be disseminated across the decentralized network of blockchain nodes, each playing a pivotal role in validating, verifying, and securely recording the transaction within their individual copies of the blockchain ledger. Through a consensus mechanism, these nodes may collectively confirm the transaction's validity, culminating in the permanent and immutable storage of the data on the blockchain. This process ensures that the data may remain tamper-resistant, transparent, and accessible while maintaining its imperviousness to unauthorized modifications, delivering robust data security within the SaaS network 102.

The blockchain module 119 may exchange private keys with the user to establish secure access to the data at step 1112. Private keys serve as unique cryptographic access keys that confirm the user's identity and ensure the confidentiality and integrity of their interactions with the blockchain. This exchange of private keys is a pivotal aspect of blockchain-based security, serving as a digital handshake between the user investor and the blockchain network 134. Private keys, generated and held by the user investor, are unique and confidential cryptographic tokens akin to digital signatures that may validate the user's identity with utmost precision. These keys are safeguarded with the highest levels of encryption, ensuring their imperviousness to external threats.

Upon exchanging private keys, the user investor may be granted exclusive and authenticated access to their data on the blockchain network 134. This access is underpinned by cryptographic protocols that guarantee the confidentiality and integrity of their interactions. Private keys not only authenticate the user but also may empower them to sign transactions, retrieve information, and manage their data securely within the SaaS network 102. This exchange of private keys may create a secure and verifiable link between the user and the blockchain network, reinforcing the trust and transparency inherent in the blockchain-based architecture. There may be scenarios where issuing multiple private keys to user investors may be appropriate. These user investors(s) may require different levels of access to various modules or data, in which case private keys can be issued, each associated with a specific role.

For example, a user investor might have one private key for general access and another for administrative tasks or managing specific transactions. Using multiple private keys may add an extra layer of security. For example, a user might have one private key for routine operations and another for high-security actions, like financial transactions or sensitive data access. This separation may help mitigate the risk of compromise in case one key is somehow exposed. If a private key is ever compromised or lost, having multiple keys may allow for more flexible revocation and recovery processes.

For example, instead of revoking all access, only the compromised key may be revoked and a new one issued which may minimize disruptions for the user investor. Multiple private keys may be used to establish more detailed audit trails, with each key associated with specific actions, making it easier to track and attribute changes or transactions to a particular user investor. In situations where regulatory compliance or internal security policies require segregation of duties, multiple private keys may enforce this separation, for example, one private key may be used for initiating a transaction, while another is needed to authorize or finalize it. Some user investors may find it more convenient to use different private keys for different purposes within the SaaS network 102; therefore, strong key management practices, such as secure storage and backup, are critical when using multiple private keys to maintain overall security. The blockchain key database 125 provides the secure storage and management of cryptographic keys at step 1114, serving as the repository for both private keys and public keys, each playing a distinct role in the blockchain authentication process.

Private keys, which are unique to each user investor, are securely stored within the blockchain key database 128. These private keys are generated during the user registration process and are never shared or exposed to anyone else. The blockchain key database 128 may employ advanced encryption techniques to safeguard the private keys, making them extremely resistant to unauthorized access ensuring the confidentiality and security of the user investor's digital credentials. Derived from the corresponding private keys, public keys are also stored within the blockchain key database 128. Public keys act as unique identifiers on the blockchain and may be used for cryptographic verification and validation. While public keys are stored within the blockchain key database 128, they do not grant direct access to the blockchain. Instead, they serve as references to the user's identity on the blockchain.

For example, a user investor named Alice wants to securely access her blockchain-based investment on the SaaS network 102, and as part of the registration process, a pair of cryptographic keys is generated for her: a private key and a public key. These keys are securely stored within the blockchain key database 128. Alice's private key is her secret cryptographic key that is kept securely on her device and is like a digital signature that only she possesses. Alice's public key is a derived key from her private key and is stored within the blockchain key database 128 and is a unique identifier for Alice on the blockchain. When Alice wants to access her investments on the blockchain network 134, she uses her private key to initiate the process, which confirms her identity in the system.

The SaaS network 102, which is integrated with the blockchain network 134, checks its private key against the corresponding public key stored in the blockchain key database 128. The public key serves as a reference to Alice's identity on the blockchain. It doesn't grant access on its own but acts as a secure way to identify her without exposing her private key. If the private key matches the stored public key, Alice is granted access to her blockchain-based investment portfolio. The SaaS system 102 uses her private key for cryptographic verification of her identity, ensuring that she is the rightful owner of the account. With access granted, Alice may securely view her investment holdings, initiate transactions, and perform other activities related to her investments on the blockchain network 134. In this example, the public key stored in the blockchain key database 128 acts as a reference to Alice's identity on the blockchain network 134. It doesn't provide direct access but is used in combination with her private key for secure authentication and verification.

This two-key system ensures that even if the public key is known, it cannot be used to compromise the security of Alice's account or the blockchain transactions. The blockchain module 119 may return to the manage module 104 at step 1116, ensuring that the entire process is seamlessly integrated into the SaaS network 102. For example, the user investor may interact with familiar screens and interfaces consistent with the rest of the SaaS network 102, while the blockchain module 119 may process complex background tasks, maintaining the utmost security and immutability of user investor data. Once the user investor concludes blockchain-related activities, whether reviewing investment or executing transactions, the blockchain module 119 may return control to the manage module 104. For example, this seamless transition may empower the user investor to continue use of the SaaS network 102 other features without interruption, ensuring a consistent and coherent user experience. The blockchain module 119 integration into the manage module 104 is vital for delivering an all-encompassing, secure, and user-centric environment within the SaaS network 102.

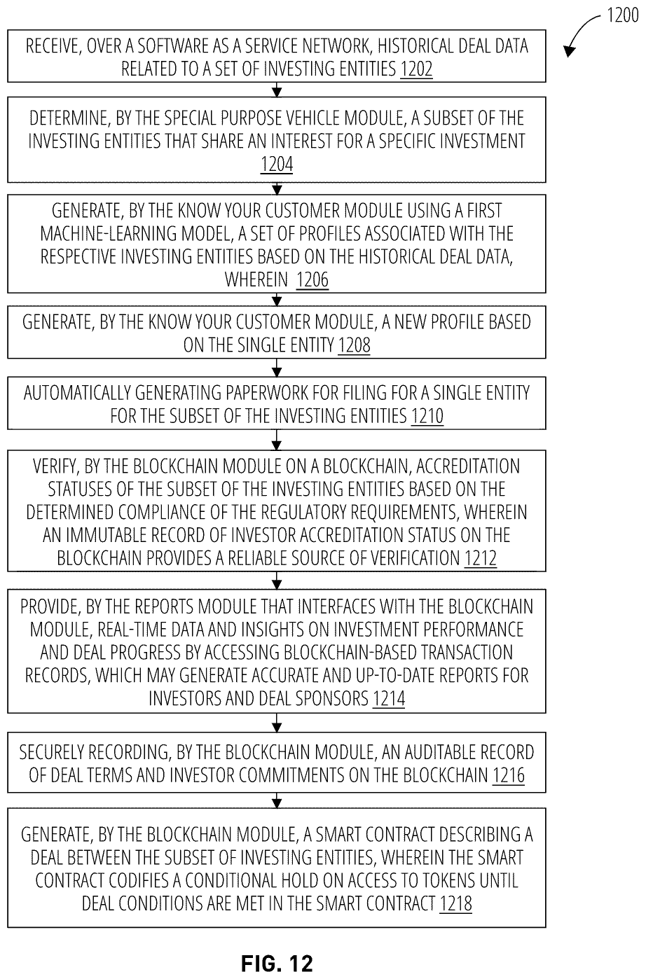

FIG. 12 illustrates an example method 1200 for deal management and blockchain execution. Although the example method 1200 depicts a particular sequence of operations, the sequence may be altered without departing from the scope of the present disclosure. For example, some of the operations depicted may be performed in parallel or in a different sequence that does not materially affect the function of the method 1200. In other examples, different components of an example device or system that implements the method 1200 may perform functions at substantially the same time or in a specific sequence. In addition, the method 1200 can be implemented using a cloud-based infrastructure, allowing for scalability and flexibility. Furthermore, the method 1200 can be integrated with other systems to provide a seamless user experience.

According to some examples, the method includes receiving, over a software as a service network, historical deal data related to a set of investing entities at step 1202. The historical data may be stored in a centralized database, allowing for efficient retrieval and analysis. The historical data may include information on past deals, investor performance, and regulatory compliance. In some cases, the method also receives real-time market data, enabling more accurate predictions and risk assessments.

According to some examples, the method includes determining, by a special purpose vehicle module, a subset of the investing entities that share an interest for a specific investment at step 1204. In some cases, the special purpose vehicle module determines the subset of the investing entities that share the interest for the specific investment using a machine-learning model. In some cases, the machine-learning model determines weights based on the training data including the sets of deals, the respective predicted investment goals, and the respective predicted risk tolerance.

According to some examples, the method includes generating, by a know your customer module using a machine-learning model, a set of profiles associated with the respective investing entities based on the historical deal data, wherein at step 1206. In some cases, the machine-learning model predicts respective investment goals and respective risk tolerance based on the historical deal data, and wherein the respective profiles include the respective predicted investment goals and the respective predicted risk tolerance.

According to some examples, the method includes generating, by the know your customer module, a new profile based on the single entity at step 1208. The new profile may be generated using updated information from the investing entity, such as changes in investment goals or risk tolerance. The new profile ensures that the system remains up-to-date and relevant to the needs of each investor.

According to some examples, the method includes automatically generating paperwork for filing for a single entity for the subset of the investing entities at step 1210. The paperwork may be generated using templates and algorithms while ensuring that all regulatory requirements are met, providing a secure and compliant environment for investment.

In some cases, a chat module may be initiated by the manage module. In some cases, the chat module sets up a chat room for the subset of the investing entities. In some cases, the chat module records messages and authorizations based on the messages in the chat room, wherein the authorizations are recorded in the blockchain. This allows investors to communicate and collaborate in real-time, enhancing the overall experience.

In some cases, a reports module may be initiated by the manage module. In some cases, the reports module generates one or more reports of portfolio performance over time associated with at least one of the specific investment or the subset of the investing entities. In some cases, the reports module determines compliance of regulatory requirements by the subset of the investing entities based on the one or more reports. The reports provide valuable insights and analytics, enabling investors to make informed decisions. The reports also ensure regulatory compliance by providing a transparent record of portfolio performance.

In some cases, a deal module may be initiated by the manage module. In some cases, the deal module outputs, using a machine-learning model, respective sets of deals that match the respective profile of the investing entity. In some cases, the machine-learning model determines weights based on training data including the respective predicted investment goals and the respective predicted risk tolerance to generated the sets of deals.

According to some examples, the method includes verifying, by the blockchain module on a blockchain, accreditation statuses of the subset of the investing entities based on the determined compliance of the regulatory requirements, wherein an immutable record of investor accreditation status on the blockchain provides a reliable source of verification at step 1212. The blockchain module uses consensus rules to validate the accreditation statuses, ensuring that all investors are held to the same standards.

According to some examples, the method includes providing, by the reports module that interfaces with the blockchain module, real-time data and insights on investment performance and deal progress by accessing blockchain-based transaction records, which may generate accurate and up-to-date reports for investors and deal sponsors at step 1214.

According to some examples, the method includes securely recording, by the blockchain module, an auditable record of deal terms and investor commitments on the blockchain at step 1216.

According to some examples, the method includes generating, by the blockchain module, a smart contract describing a deal between the subset of investing entities, wherein the smart contract codifies a conditional hold on access to tokens until deal conditions are met in the smart contract at step 1218. In some cases, the deal conditions are based on parameters in the special purpose vehicle module that includes at least one of a specific legal structure, a statement of the purpose and investment strategy within the Software as a Service network, a list of user investors and specific amounts contributed by each user investor, governance structure, decision-making processes, or voting rights.

In some cases, a plurality of tokens are maintained in a blockchain database. In some cases, a set of tokens are released between the subset of investing entities upon completion of the deal conditions.

In some cases, the blockchain module validates the releasing of the tokens based on consensus rules that require at least a percentage of validators to agree on the token release. This provides a seamless and integrated experience, enabling investors to make informed decisions.

In some cases, based on a triggering event for another condition for lowering risk based on the profiles of the subset of investing entities, at least one of the tokens are automatically swapped for risk mitigation tokens.

In some cases, a gift module may be initiated by the manage module. In some cases, the gift module may receive a record of a new gift transfer. The gift module may further conduct compliance verification with regulatory standards. In some cases, the gift module may determine suitability of contributions to accounts based on the new gift transfer. The gift module may further generate a tax scenario analysis based on the contributions.

FIG. 13 illustrates a block diagram of an exemplary computing system that may be used to implement an embodiment of the present invention. The example of computer system 1300 can be for example any computing device making up 100, or any component thereof in which the components of the system are in communication with each other using connection 1301. Connection 1301 can be a physical connection via a bus, or a direct connection into processor 1302, such as in a chipset architecture. Connection 1301 can also be a virtual connection, networked connection, or logical connection.

In some embodiments, computing computer system 1300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing computer system 1300 includes at least one processing unit (CPU or processor) 1302 and connection 1301 that couples various system components including system memory 1304, such as read-only memory (ROM) 1305 and random access memory (RAM) 1306 to processor 1302. Computing computer system 1300 can include a cache of high-speed memory 1304 connected directly with, in close proximity to, or integrated as part of processor 1302.

Processor 1302 can include any general purpose processor and a hardware service or software service, such as services 1308, 1309, and 1310 stored in storage devices 1307, configured to control processor 1302 as well as a special-purpose processor where software instructions are incorporated into the actual processor design. Processor 1302 may essentially be a completely self-contained computing system, containing multiple cores or processors, a bus, memory controller, cache, etc. A multi-core processor may be symmetric or asymmetric.

To enable user interaction, computing computer system 1300 includes an input device 1313, which can represent any number of input mechanisms, such as a microphone for speech, a touch-sensitive screen for gesture or graphical input, keyboard, mouse, motion input, speech, etc. Computing system 1300 can also include output device 1311, which can be one or more of a number of output mechanisms known to those of skill in the art. In some instances, multimodal systems can enable a user to provide multiple types of input/output to communicate with computer system 1300. Computing system 1300 can include communication interface 1312, which can generally govern and manage the user input and system output. There is no restriction on operating on any particular hardware arrangement, and therefore the basic features here may easily be substituted for improved hardware or firmware arrangements as they are developed.

Storage device 1307 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1307 can include software services, servers, services, etc., that when the code that defines such software is executed by the processor 1302, it causes the system to perform a function. In some embodiments, a hardware service that performs a particular function can include the software component stored in a computer-readable medium in connection with the hardware components, such as processor 1302, connection 1301, output device 1311, etc., to carry out the function.

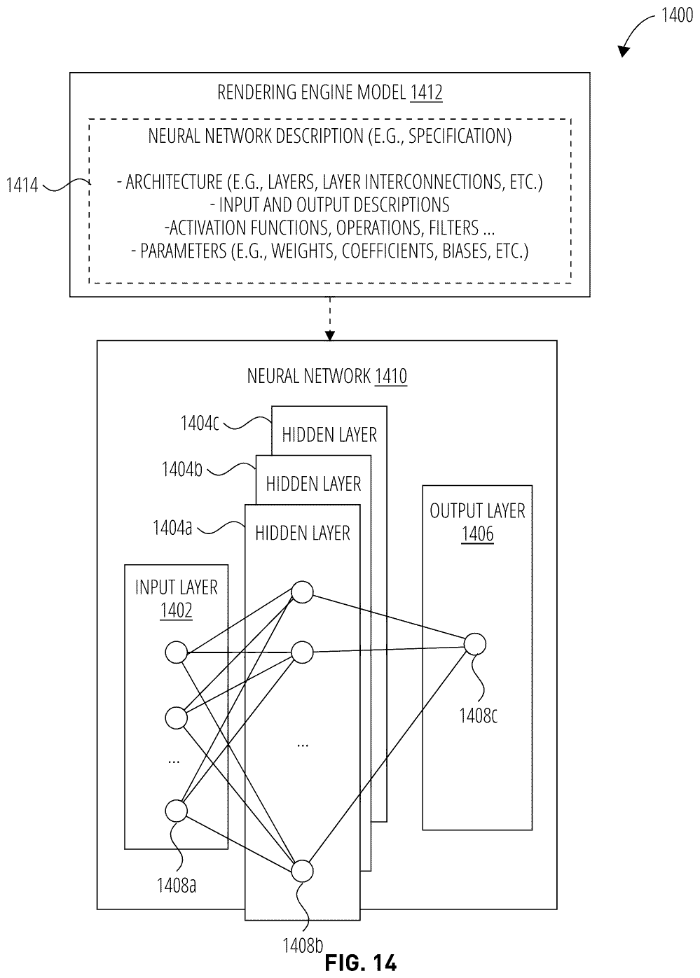

FIG. 14 illustrates an example neural network architecture.

Architecture 1400 includes a neural network 1404c defined by an example neural network description 1408a in node 1410c (neural controller). The neural network 6100 can represent a neural network implementation of a rendering engine for rendering media data. The neural network description 1408a can include a full specification of the neural network 1404c, including the neural network architecture 1400. For example, the neural network description 1408a can include a description or specification of the architecture 1400 of the neural network 1404c (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 1404c reflects the architecture 1400 defined in the input layer 1402. In this example, the neural network 1404c includes an input layer 1402, which includes input data, such i###. In one illustrative example, the input layer 1402 can include data representing a portion of the input media data such as a patch of data or pixels (e.g., a 728×728 patch of data) in an image corresponding to the input media data (e.g., that of user 702 and/or selected product(s) 708). The neural network 1404c includes hidden layers 504a through 604 N (collectively “604” hereinafter). The hidden layers 604 can include n number of hidden layers, where n is an integer greater than or equal to one. The number of hidden layers can include as many layers as needed for a desired processing outcome and/or rendering intent.

The neural network 1404c further includes an output layer 1404b that provides an output (e.g., rendering output) resulting from the processing performed by the hidden layers 604. In one illustrative example, the output layer 1404b can provide ###. The neural network 1404c in this example is a multi-layer neural network of interconnected nodes. Each node can represent a piece of information. Information associated with the nodes is shared among the different layers and each layer retains information as information is processed. In some cases, the neural network 1404c can include a feed-forward neural network, in which case there are no feedback connections where outputs of the neural network are fed back into itself. In other cases, the neural network 1404c can include a recurrent neural network, which can have loops that allow information to be carried across nodes while reading in input. Information can be exchanged between nodes through node-to-node interconnections between the various layers.

Nodes of the input layer 1402 can activate a set of nodes in the first hidden layer 504a. For example, as shown, each of the input nodes of the input layer 1402 is connected to each of the nodes of the first hidden layer 504a. The nodes of the hidden layers hidden layer 504a can transform the information of each input node by applying activation functions to the information. The information derived from the transformation can then be passed to and can activate the nodes of the next hidden layer (e.g., 504b), which can perform their own designated functions. Example functions include convolutional, up-sampling, data transformation, pooling, and/or any other suitable functions. The output of the hidden layer (e.g., 504b) can then activate nodes of the next hidden layer (e.g., 604N), and so on. The output of the last hidden layer can activate one or more nodes of the output layer 1404b, at which point an output is provided. In some cases, while nodes (e.g., nodes 508a, 508b, 508c) in the neural network 1404c are shown as having multiple output lines, a node has a single output and all lines shown as being output from a node represent the same output value. In some cases, each node or interconnection between nodes can have a weight that is a set of parameters derived from training the neural network 1404c.

For example, an interconnection between nodes can represent a piece of information learned about the interconnected nodes. The interconnection can have a numeric weight that can be tuned (e.g., based on a training dataset), allowing the neural network 1404c to be adaptive to inputs and able to learn as more data is processed. The neural network 1404c can be pre-trained to process the features from the data in the input layer 1402 using the different hidden layers 604 in order to provide the output through the output layer 1404b. In an example in which the neural network 1404c is used to identify ###, the neural network 1404c can be trained using training data that includes example images and facial features of user and/or labeling and characteristic information (e.g., name, brand, size, etc.) of product(s). For instance, training images can be input into the neural network 1404c, which can be processed by the neural network 1404c to generate outputs which can be used to tune one or more aspects of the neural network 1404c, such as weights, biases, etc. In some cases, the neural network 1404c can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 1404c, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 1404c is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 1404c can perform a backward pass by determining which inputs (weights) most contributed to the loss of the neural network 1404c, and can adjust the weights so that the loss decreases and is eventually minimized. A derivative of the loss with respect to the weights can be computed to determine the weights that contributed most to the loss of the neural network 1404c. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1404c can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 1404c can represent any other neural or deep learning network, such as an autoencoder, a deep belief nets (DBNs), a recurrent neural networks (RNNs), etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of managing deal data using blockchain, the method comprising:
receiving, over a Software as a Service network, historical deal data related to a set of different entities;
filtering the set of entities to determine a filtered subset associated with data regarding a shared interest type;
generating a set of profiles associated with the subset of entities based on use of a first machine-learning model to analyze the historical deal data;
automatically generating a custom set of filing documents for a single entity from the subset of the investing entities;
generating a new profile based on the single entity;
verifying accreditation statuses of the subset of the investing entities by reference to an immutable record of accreditation status on the blockchain;
securely recording on the blockchain an auditable record of terms and commitments; and
generating a smart contract describing a deal between the subset of investing entities, wherein the smart contract codifies a conditional hold on access to tokens until deal conditions specified by the smart contract are determined to have been met.

2. The computer-implemented method of claim 1, further comprising:
identifying a triggering event for another condition for lowering risk based on the profiles of the subset of investing entities; and
automatically swapping at least one of the tokens for one or more risk mitigation tokens.

3. The computer-implemented method of claim 1, further comprising:
maintaining a plurality of tokens in a blockchain database; and
releasing a set of tokens between the subset of entities upon completion of the deal conditions.

4. The computer-implemented method of claim 3, further comprising validating the release of the tokens based on one or more consensus rules that require at least a percentage of validators to agree on the token release.

5. The computer-implemented method of claim 1, further comprising:
setting up an online chat room for the subset of the entities; and
recording one or more messages and authorizations based on the messages in the chat room, wherein the authorizations are recorded in the blockchain.

6. The computer-implemented method of claim 1, further comprising:
generating one or more reports of performance over time associated with at least one of the deal or the subset of the entities; and
determining compliance of the regulatory requirements by the subset of the entities based on the one or more reports.

7. The computer-implemented method of claim 6, further comprising generating one or more reports that include real-time data and insights on performance and deal progress by accessing blockchain-based transaction records.

8. The computer-implemented method of claim 1, further comprising:
generating one or more predictions regarding one or more of the entities based on use of the first machine learning model to analyze the historical deal data; and
updating one or more respective profiles based on the predictions.

9. The computer-implemented method of claim 1, further comprising:
using a second machine-learning model to analyze the historical deal data correlated to a profile of a selected one of the entities; and
outputting one or more respective sets of deals selected for the selected entity.

10. The computer-implemented method of claim 9, wherein the second machine-learning model identifies the sets of deals in accordance one or more weights selected based on the profile of the selected entity and training data that include respective goals and the respective risk tolerance.

11. The computer-implemented method of claim 9, wherein filtering the set of entities to determine the filtered subset associated with data regarding the shared interest type includes using a third machine-learning model to analyze the historical deal data.

12. The computer-implemented method of claim 11, wherein the third machine-learning model determines the filtered subset in accordance with one or more weights selected based on training data that include a set of deal data associated with respective goals and respective risk tolerance.

13. The computer-implemented method of claim 1, further comprising:
receiving a data record regarding a new gift transfer;
conducting compliance verification of the data record in relation to one or more regulatory standards, wherein conducting the compliance verification includes determining one or more account contributions suitable for the new gift transfer; and
generating an analysis based on the determined account contributions.

14. The computer-implemented method of claim 1, wherein the deal conditions includes at least one of a specific legal structure, a statement of the purpose and investment strategy within the Software as a Service network, a list of user investors and specific amounts contributed by each user investor, governance structure, decision-making processes, or voting rights.

15. An integrated deal management and blockchain system comprising:
a communication interface that communicates over a communication network with a Software as a Service network platform to receive historical deal data related to a set of different entities and with a blockchain; and
a processor that executes instructions stored in memory, wherein the processor executes the instructions to:
filter the set of entities to determine a filtered subset associated with data regarding a shared interest type;
generate a set of profiles associated with the subset of entities based on use of a first machine-learning model to analyze the historical deal data;
automatically generate a custom set of filing forms for a single entity from the subset of the investing entities;
generate a new profile based on the single entity;
verify accreditation statuses of the subset of the investing entities by reference to an immutable record of accreditation status on the blockchain;
securely record on the blockchain an auditable record of terms and commitments; and
generate a smart contract describing a deal between the subset of investing entities, wherein the smart contract codifies a conditional hold on access to tokens until deal conditions specified by the smart contract are determined to have been met.

16. The system of claim 15, further comprising memory that stores communication logic executable to exchange data of the smart contract with a blockchain database of the blockchain.

17. The system of claim 16, wherein at least one node of the Software as a Service network executes virtual machine logic to incorporate the data of the smart contract into the blockchain database.

18. The system of claim 15, wherein the processor executes further instructions to validate release of the tokens based on one or more consensus rules that require at least a percentage of validators to agree on the token release.

19. The system of claim 15, wherein the processor executes further instructions to:
set up a chat room for the subset of the entities; and
record one or more messages and authorizations based on the messages in the chat room, wherein the authorizations are recorded in the blockchain.

20. A non-transitory computer-readable storage medium having instructions embodied thereon, the instructions executable by a computing system to perform a method of managing deal data using blockchain, the method comprising:
receiving, over a Software as a Service network, historical deal data related to a set of different entities;
filtering the set of entities to determine a filtered subset associated with data regarding a shared interest type;
generating a set of profiles associated with the subset of entities based on use of a first machine-learning model to analyze the historical deal data;
automatically generating a custom set of filing documents for a single entity from the subset of the investing entities;
generating a new profile based on the single entity;
verifying accreditation statuses of the subset of the investing entities by reference to an immutable record of accreditation status on the blockchain;
securely recording on the blockchain an auditable record of terms and commitments; and
generating a smart contract describing a deal between the subset of investing entities, wherein the smart contract codifies a conditional hold on access to tokens until deal conditions specified by the smart contract are determined to have been met.
